(19) United States
(12) Patent Application Publication
(10) Pub. No.: US 2015/0254462 A1
(43) Pub. Date: Sep. 10, 2015

(54) INFORMATION PROCESSING DEVICE THAT PERFORMS ANONYMIZATION, ANONYMIZATION METHOD, AND RECORDING MEDIUM STORING PROGRAM

(71) Applicant: NEC Corporation, Tokyo (JP)

(72) Inventor: Tsubasa Takahashi, Tokyo (JP)

(73) Assignee: NEC CORPORATION, Tokyo (JP)

(21) Appl. No.: 14/431,145

(22) PCT Filed: Sep. 12, 2013
(86) PCT No.: PCT/JP2013/005392

§ 371 Date: Mar. 25, 2015

(30) Foreign Application Priority Data
Sep. 26, 2012 (JP) 2012-212454

(51) Int. Cl. G06F 21/60; G06F 21/62; G06F 17/30

(52) U.S. Cl. CPC G06F 21/60; G06F 17/30864; G06F 21/6254

(57) ABSTRACT

The present invention provides an information processing device that performs anonymization such that information on correspondence relationships between records does not become too unclear.

This information processing device includes: a means that extracts plural sets of second records from sets of a first record containing a first attribute and a second record containing a second attribute, which have the same specific identifier, on the basis of enabling to satisfy a second and a first l-diversity in a second record group and a first record group corresponding to the second record group respectively, and a level of abstraction of correspondence relationship between the first and the second records; and a means that generates an anonymous-group data set including a set of second records so as to satisfy the second l-diversity in the set of second records and so as to satisfy the first l-diversity in a set of corresponding first records.

### TECHNICAL FIELD

The present invention relates to an information processing device, an anonymization method and a program thereof which anonymize information, whose disclosure or usage in a form of original information contents is considered to be undesirable, such as personal information or the like.

### BACKGROUND ART

Log information, which is generated from daily service activities provided to a user by a service provider, such as a purchase history, a medical care history or the like, is stored by the service provider as history information. By analyzing the history information, it is possible to grasp an action pattern of a specific user, and to grasp a specific tendency of a group, and to predict an event which is likely to occur in future, and to carry out factor analysis to a past event, etc. By using the history information and the analysis result, the service provider can make an own business strong or review the own business. Accordingly, the history information has a very high usage value and is useful information. Here, the group is a group which includes a plurality of users.

The history information which the service provider holds is useful also for a third party other than the service provider. For example, by using the history information, the third party can obtain information which the third party cannot obtain by himself. Accordingly, the third party can strengthen the own service and marketing. Moreover, there is a case that the service provider requests the third party to analyze the history information, or there is also a case that the service provider discloses the history information for research

There is a case that the history information, which has the very high usage value, contains information which a subject of the history information desires not to be disclosed to another person, or information which should not be disclosed to the third party. In general, the information is called sensitive information (Sensitive Attribute (SA), or Sensitive Value). For example, in the case of the purchase history, purchased goods can be the sensitive information. Moreover, in the case of the medical care history, a name of sickness or injury, or a name of medical care is the sensitive information.

There are many cases that the history information is assigned a user identifier (user ID) which identifies a service user with one to one correspondence, and a plurality of attributes (attribute information) which characterize the service user. A name, a member's number, an insured person's number or the like is corresponding to the user identifier. Sexuality, a date of birth, a job, a residence area, a Zip code or the like is corresponding to the attribute which characterizes the service user. The service provider records the user identifier, a plurality of kinds of attribute and the sensitive information as one record. Then, the service provider stores the record as the history information at every time when a corresponding user (service user) receives a service. If the history information, which is in a state of being assigned the user identifier, is provided to a third party, the third party can identify the service user by using the user identifier. Therefore, a problem of privacy infringement can be caused.

Moreover, there is a case that an individual may be identified by combining one or more attributes, each of which is assigned each record, out of a data set including a plurality of records. The attribute which can identify the individual is called ‘quasi-identifier’. That is, even if the user identifier of the individual is removed from the history information, the privacy infringement can be caused as far as the individual can be identified on the basis of the quasi-identifier.

On the other hand, if all of the quasi-identifiers are removed from the history information, it is impossible to carry out a statistical analysis. Accordingly, a large amount of original usefulness of the history information is lost. The statistical analysis is, for example, an analysis on history information from which all of the Quasi-identifiers are removed. Specifically, it is impossible to carry out an analysis on a product which a generation is likely to purchase willingly, an analysis of a specific sickness or injury which a residence in a specific area suffers from, or the like.

As a method to convert a data set of history information, which has the above-mentioned characteristics, into a form which protects privacy with holding original availability, the anonymization is known.

For example, PTL 1 discloses an art to classify input data into a quasi-identifier or important information per an attribute, and to output a data set which satisfies ‘k-anonymity’ in each quasi-identifier and ‘l-diversity’ in all pieces of the important information.

NPL 1 proposes the k-anonymity which is the most known anonymity index. A method to make a data set, which is an anonymization target, satisfy the k-anonymity, is called ‘k-anonymization’. In the k-anonymization, a process, which converts target quasi-identifiers so that there may be at least k or more records, each of which has the same quasi-identifier, in a data set which is an anonymization target, is carried out. Generalization, cutting off or the like is known as the conversion process. In the generalization, original detailed information is converted into abstracted information.

NPL 2 proposes the l-diversity which is one of anonymity indexes developing the k-anonymity. A method to make a data set, which is an anonymization target, satisfy the l-diversity, is called ‘l-diversification’. In the l-diversification, a process of converting the quasi-identifier, which is a target, is carried out so that at least l kinds of sensitive information different each other may be included in a plurality of records each having the same quasi-identifier.

Here, the k-anonymization guarantees that number of records associated with the quasi-identifier is k or more. Moreover, the l-diversification guarantees that number of kinds of sensitive information associated with the quasi-identifier is 1 or more.

According to the k-anonymization and the l-diversification mentioned above, in the case that there are plural records each of which has the same user identification, a correspondence relationship between events different each other (in other words, characteristics, transition and property: hereinafter, called ‘correspondence relationship’ in the present application) such as an order of the record and the relationship between the records is not taken into consideration. Therefore, there is a case that characteristic between the records become unclear or lost.

Moreover, as an anonymization method, whose target is plural records each having the same user identification and which stores an order on the time axis, the anonymization for the moving locus is known.

NPL 3 is a paper on an art of anonymizing a moving locus whose position information is associated with a time sequence. More specifically, the anonymization described in NPL 3 is an anonymization which guarantees consistent k-anonymity by regarding a moving locus from a start point to an end point to be a series of sequence. According to the anonymization of the moving locus, an anonymous moving locus, which is in a form of tube binding k or more moving loci which are similar geographically, is generated. According to the anonymization of the moving locus, an anonymous moving locus, which has the maximum geographical similarity under restriction of the anonymity, is generated.

According to the anonymization method for the moving locus whose typical example is NPL 3, especially, a time-sequential order relationship out of characteristics existing among records each of which has the same identifier is held.

### CITATION LIST

### Patent Literature

PTL 1: Japanese Patent Application Publication No. 2012-003440 Non Patent Literature
NPL 1: L. Sweeney, “k-anonymity: a model for protecting privacy”, International Journal on Uncertainty, Fuzziness and Knowledge-based Systems, 10(5), pp. 555-570, 2002.
NPL 2: A. Machanavajjhala, D. Kifer, J. Gehrke and M. Venkitasubramaniam, “l-Diversity: Privacy Beyond k-Anonymity”, ACM Transactions on Knowledge Discovery from Data, Volume 1 Issue 1, March 2007 Article No. 3.
NPL 3: O. Abul, F. Bonchi and M. Nanni [symbol] “Never Walk Alone: Uncertainty for Anonymity in Moving Objects Databases.” In Proceedings of 24th IEEE International Conference on Data Engineering, pp. 376-385, 2008.

### SUMMARY OF INVENTION

### Technical Problem

However, the arts, which are described in the patent literature and the non patent literature mentioned above, have a problem that, in the case that anonymization is carried out to a data set, which includes information on correspondence relationship, so as to satisfy the l-diversity, the information may become too unclear in some cases. Here, the information on ‘correspondence relationship’ is information on ‘correspondence relationship between records each of which has the same specific identifier (user identifier). Here, the data set, for example, is a data set which includes a plurality of records and which includes one or more sets of records each having the same specific identifier.

The l-diversity is defined in the data set, for example, per a record group which includes a portion of records of the data set. Then, the data set is anonymized so as to satisfy the l-diversity of the record group. In this situation, there is a case that ‘correspondence relationship between the records, each of which has the same specific identifier’ and which are included in the anonymized data set, becomes too unclear in comparison with one of the original data set.

The reason why there is the case that the information (information on ‘correspondence relationship’) becomes too unclear will be shown in the following.

According to the arts described in the patent literature and the non patent literature, considerations, which are necessary to maintain the information on ‘correspondence relationship between records each of which has the same specific identifier’, are not taken. Therefore, there is a case that, in the case that a data set is anonymized so as to satisfy the l-diversity which is defined per the record group of the data set, excessive ‘correspondence relationship, which the original data set does not include and which exist between the records each having the same specific identifier’, is added.

PTL 1 does not take the information on ‘correspondence relationship between records each of which has the same specific identifier’ into consideration.

NPL 1 does not disclose an art on the l-diversity.

In the case of NPL 2, a main object is to construct an anonymous moving locus which has the maximum geographical similarity.

Accordingly, characteristics (correspondence relationship) between the records are not always maintained. Moreover, NPL 3 does not cope with the guarantee of anonymity of the l-diversity.

Next, a specific example will be explained.

FIG. 28 is a diagram showing an example of a pre-anonymization data set. The pre-anonymization data set shown in FIG. 28 includes a plurality of first records and a plurality of second records. The first record includes attributes of a specific identifier, a medical care month, an age and a name of sickness, and an attribute value of the medical care month is ‘April’. The second record includes attributes of a specific identifier, a medical care month, an age and a name of sickness, and an attribute value of the medical care month is ‘May’.

Moreover, the pre-anonymization data set includes information on relationship between the first record and the second record each of which has the same specific identifier. For example, the correspondence relationship between ‘U’ which is an attribute value of the sickness name included in the first record having a specific identifier ‘1’, and ‘A’ which is an attribute value of the sickness name included in the second record having a specific identifier ‘1’ (hereinafter, the correspondence relationship is denoted as ‘U-A’).

FIG. 29 is a diagram showing an example of a post-anonymization data set which is generated by anonymizing the pre-anonymization data set shown in FIG. 28. The post-anonymization data set shown in FIG. 29 is generated by carrying out anonymization so that a first record group including the first record of the pre-anonymization data set may satisfy the l-diversity whose l is 3. Moreover, the post-anonymization data set shown in FIG. 29 is generated by carrying out anonymization so that a second record group including the second record of the pre-anonymization data set may satisfy the l-diversity whose l is 2.

For example, records whose specific identifiers are ‘6’, ‘7’ and ‘9’ in the pre-anonymization data set shown in FIG. 28 are assigned the same group identifier ‘101’ in the post-anonymization data set in place of the specific identifier. Moreover, the records each of which has the same group identifier are generalized so that each attribute value of an attribute, which is the quasi-identifier, may have the same value.

In the pre-anonymization data set shown in FIG. 28, ‘correspondence relationships between records (records whose specific identifiers are ‘6’, ‘7’ and ‘9’) each of which has the same specific identifier′ are ‘Y-E’, ‘X-D’ and ‘W-C’.

Meanwhile, in the post-anonymization data set shown in FIG. 29, ‘correspondence relationships between records each of which has the same specific identifier’ (corresponding to group identifier ‘101’) are ‘Y-E’, ‘Y-D’, ‘Y-C’, ‘X-E’, ‘X-D’, ‘X-C’, ‘W-E’, ‘W-D’ and ‘W-C’. That is, the post-anonymization data set includes excessively ‘Y-C’ and ‘W-E’ which do not exist in the pre-anonymization data set shown in FIG. 28 and which are ‘correspondence relationship between records each having the same specific identifier’.

The above is the specific example of the problem that the information on ‘correspondence relationship between records each of which has the same specific identifier’ becomes too unclear.

An object of the present invention is to provide an information processing device, an anonymization method and a program thereof which solve the above-mentioned problem.

An information processing device according to one aspect of the present invention includes:

a record extraction means for extracting a plurality of second records from a data set, which includes plural sets of a first record including a specific identifier and at least one first attribute, and said second record including the same specific identifier as said specific identifier of said first record and at least one second attribute, on the basis that it is possible to satisfy a second l-diversity in a second record group including plural said second record, and it is possible to satisfy a first l-diversity in a first record group including said first record which makes the set with said second record included in said second group, and on the basis of a level of abstraction of a correspondence relationship existing between said first record and said second record; and

an anonymous group generation means for generating an anonymous group data set including said second record, which is extracted by said record extraction means, so as to satisfy said second l-diversity in said anonymous group data set and so as to satisfy said first l-diversity in said first record group including said first record which makes the set with said second record included in said anonymous group data set, and outputting said generated anonymous group data set.

An anonymization method according to one aspect of the present invention, which a computer:

extracts a plurality of second records from a data set, which includes plural sets of a first record including a specific identifier and at least one first attribute, and said second record including the same specific identifier as said specific identifier of said first record and at least one second attribute, on the basis that it is possible to satisfy a second l-diversity in a second record group including said second record, and it is possible to satisfy a first l-diversity in a first record group including said first record which makes the set with said second record included in said second group, and on the basis of a level of abstraction of a correspondence relationship existing between said first record and said second record; and

generates an anonymous group data set including said extracted second record so as to satisfy said second l-diversity in said anonymous group data set and so as to satisfy said first l-diversity in said first record group including said first record which makes the set with said second record included in said anonymous group data set, and outputs said generated anonymous group data set.

A computer-readable non-volatile recording medium according to one aspect of the present invention storing a program for making a computer execute:

a process to extract a plurality of second records from a data set, which includes plural sets of a first record including a specific identifier and at least one first attribute, and said second record including the same specific identifier as said specific identifier of said first record and at least one second attribute, on the basis that it is possible to satisfy a second l-diversity in a second record group including said second record, and it is possible to satisfy a first l-diversity in a first record group including said first record which makes the set with said second record included in said second group, and on the basis of a level of abstraction of a correspondence relationship existing between said first record and said second record; and

a process to generate an anonymous group data set including said extracted second record so as to satisfy said second l-diversity in said anonymous group data set and so as to satisfy said first l-diversity in said first record group including said first record which makes the set with said second record included in said anonymous group data set, and to output said generated anonymous group data set.

### Advantageous Effects of Invention

The present invention has an effect that, in the case of carrying out anonymization to a data set, which includes information on ‘correspondence relationship between records each of which has the same specific identifier’(user identifier), so as to satisfy the l-diversity, it is possible to prevent that the information on correspondence relationship becomes too unclear.

### BRIEF DESCRIPTION OF DRAWINGS

FIG. 1 is a block diagram showing a configuration of an anonymization device according to a first exemplary embodiment.

FIG. 2 is a block diagram showing a system which includes the anonymization device according to the first exemplary embodiment.

FIG. 3 is a diagram showing an example of a data set.

FIG. 4 is a diagram showing an example of a sorted assumption record portion.

FIG. 5 is a diagram showing an example of a sorted conclusion record portion.

FIG. 6 is a diagram showing an example of an assumption anonymous group data set.

FIG. 7 is a diagram showing an example of a conclusion anonymous group data set.

FIG. 8 is a diagram showing an example of an extracted record group.

FIG. 9 is a diagram showing an example of an extracted conclusion record group which collects the conclusion record.

FIG. 10 is a diagram showing an example of a common portion record group.

FIG. 11 is a diagram showing an example of a common portion conclusion record group which collects the conclusion record per the assumption records each having the same assumption attribute value.

FIG. 12 is a diagram showing an example of a conclusion sort record group.

FIG. 13 is a diagram showing an example of a conclusion sort conclusion record group which collects the conclusion records each having the same conclusion attribute value.

FIG. 14 is a diagram showing an example of an anonymous group conclusion record group.

FIG. 15 is a diagram showing an example of an anonymous group conclusion record group which collects the conclusion record per a group identifier.

FIG. 16 is a diagram showing a hardware configuration of a computer which realizes the anonymization device according to the exemplary embodiment.

FIG. 17 is a flowchart showing an operation of the exemplary embodiment.

FIG. 18 is a diagram showing an example of a residual record.

FIG. 19 is a diagram showing an example of a conclusion anonymous group.

FIG. 20 is a diagram showing an example of the conclusion anonymous group.

FIG. 21 is a diagram showing an example of the conclusion anonymous group.

FIG. 22 is a block diagram showing a configuration of an anonymization device 200 according to a second exemplary embodiment.

FIG. 23 is a diagram showing an example of a combination of transition vectors.

FIG. 24 is a diagram showing an example of a combination of two transition vectors.

FIG. 25 is a diagram showing whether a level of similarity between the transition vectors is ‘0’ or not.

FIG. 26 is a diagram showing an example of the transition vectors except for the transition vector which has been used.

FIG. 27 is a diagram showing an example of a combination of the transition vectors.

FIG. 28 is a diagram showing an example of a pre-anonymization data set.

FIG. 29 is a diagram showing an example of a post-anonymization data set.

### DESCRIPTION OF EMBODIMENTS

An embodiment for carrying out the present invention will be explained in detail with reference to a drawing. Here, in each drawing and each exemplary embodiment described in the description, a similar component is assigned a similar code, and explanation on the component is omitted preferably.

### First Exemplary Embodiment

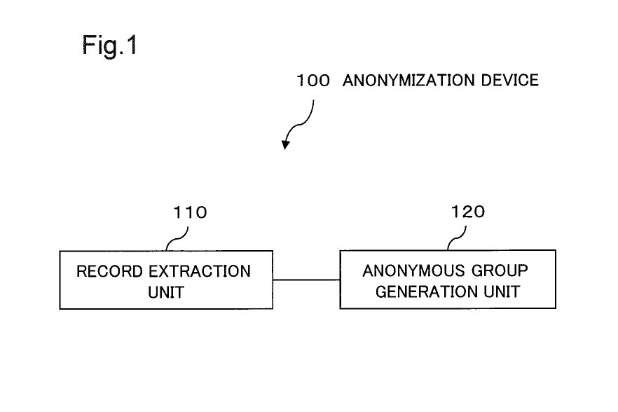

FIG. 1 is a block diagram showing an anonymization device 100 according to a first exemplary embodiment of the present invention. Here, in general, the anonymization device (anonymization device 100) is called an information processing device.

As shown in FIG. 1, the anonymization device 100 according to the exemplary embodiment includes a record extraction unit 110 and an anonymous group generation unit 120.

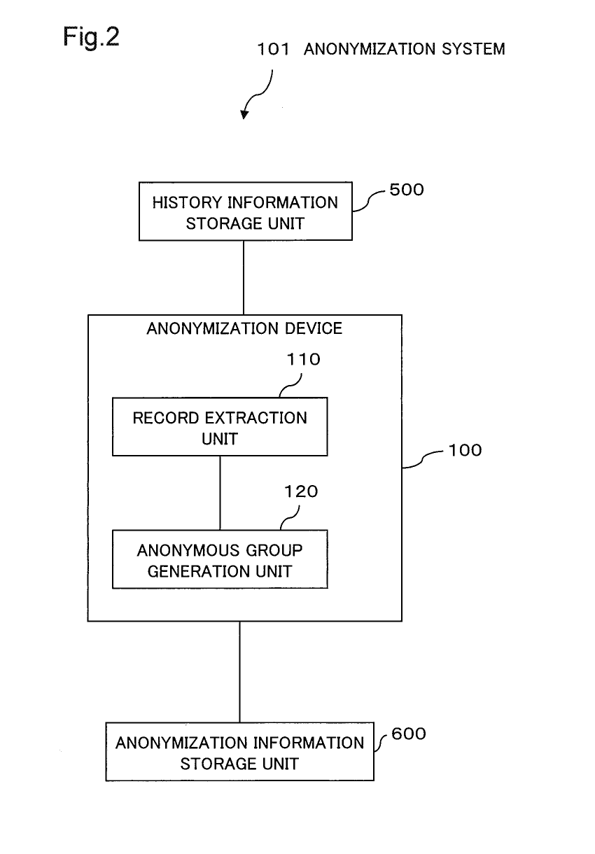

FIG. 2 is a block diagram showing a configuration of a system 101 which includes the anonymization device 100.

As shown in FIG. 2, the system 101 includes the anonymization device 100, a history information storage unit 500 and an anonymization information storage unit 600.

Firstly, an operation of the anonymization device 100 of the anonymization system 101 will be explained in the following.

===History Information Storage Unit 500===

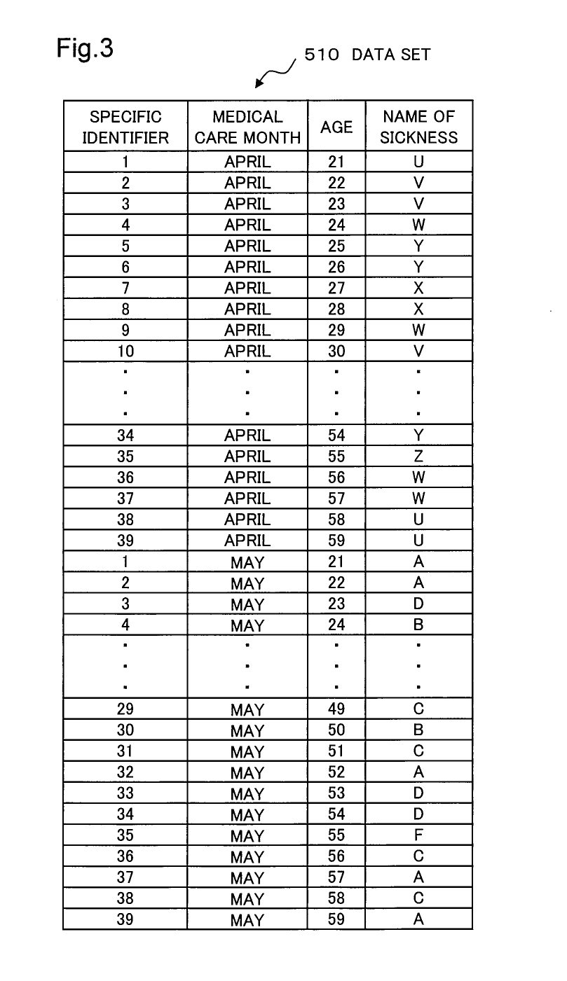

The history information storage unit 500 stores a data set 510 shown in FIG. 3. As shown in FIG. 3, the data set 510 is, for example, history information including a plurality of records each of which includes a specific identifier, and attributes of a medical care month, an age and a name of sickness. Moreover, the data set 510 includes information on a correspondence relationship between a record (assumption record) having an attribute value ‘April’ of ‘medical care month’ and a record (conclusion record) having an attribute value ‘May’ of ‘medical care month’ each of which has the same specific identifier.

The assumption record and the conclusion record may not include the same attribute. For example, the data set may be such that the assumption record includes only a specific identifier and a certain sensitive attribute, and the conclusion record includes only a specific identifier and another sensitive attribute.

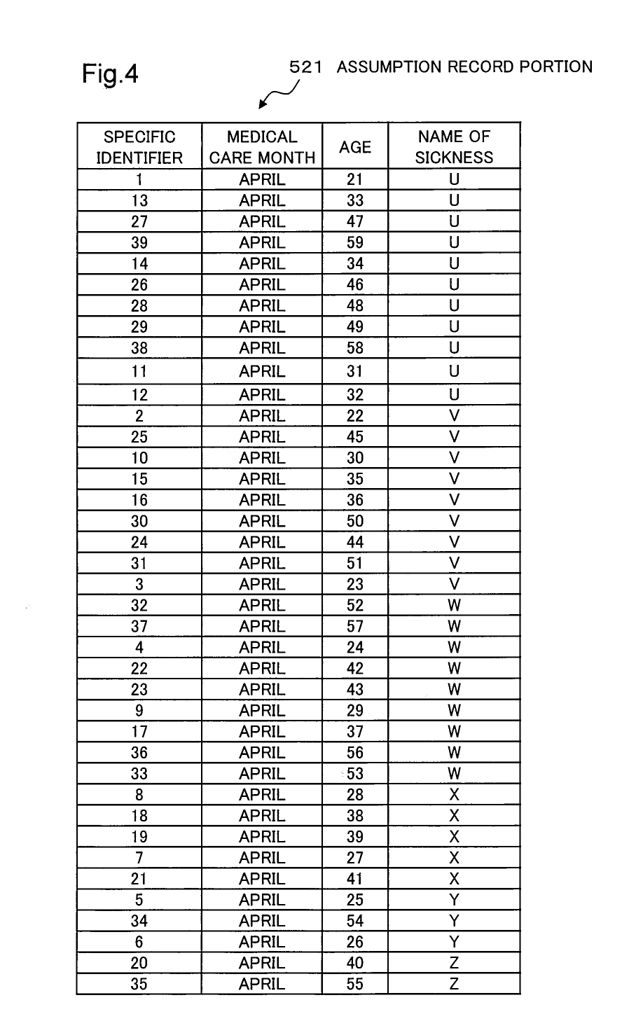

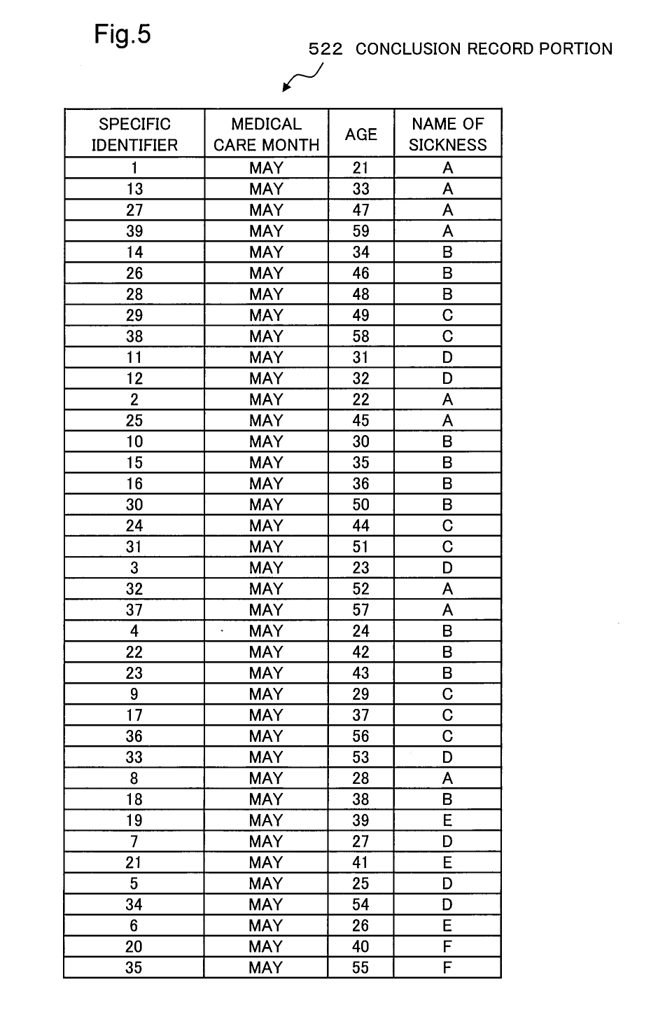

FIG. 4 and FIG. 5 are diagrams showing an assumption record (first record) portion and a conclusion record (second record) portion respectively into which the data set 510 shown in FIG. 3 is divided for convenience of explaining the following. That is, the assumption record portion 521 shown in FIG. 4 and the conclusion record portion 522 shown in FIG. 5 are not generated by the anonymization device 100, and these drawings are shown for convenience of explanation. FIG. 4 shows the assumption record portion 521 which includes the assumption record. FIG. 5 shows the conclusion record portion 522 which includes the conclusion record.

In the following exemplary embodiment, a method for anonymizing the conclusion record portion 522 so as to maintain the correspondence relationship, which exists between the assumption record portion 521 and the conclusion record portion 522, with reference to the assumption record portion 521.

===Anonymization Device 100===

The anonymization device 100 extracts a plurality of conclusion records (also called a conclusion record group or a first record group) from the data set 510, and furthermore extracts a plurality of conclusion records from the conclusion record group on the basis of a level of abstraction of the correspondence relationship. Here, the plural conclusion records which are included in the conclusion record group are a plurality of conclusion records which can satisfy a second l-diversity in the conclusion record group, and the plural conclusion records are such that a first l-diversity can be satisfied in a plurality of assumption records (also called an assumption record group or the first record group) each of which makes a set with each conclusion record.

Next, the anonymization device 100 generates a conclusion anonymous group data set (also called an anonymous group data set), which includes the conclusion record, from the extracted plural conclusion records, and outputs the generated conclusion anonymous group data set. Here, the conclusion record is a record which can be anonymized by satisfying a second l-diversity, and satisfying the first l-diversity in the first record group which has the correspondence relationships with the extracted plural conclusion records.

Moreover, the anonymization device 100 may assign the correspondence relationship, which exists between each assumption record included in the assumption anonymous group data set, and each conclusion record included in the anonymous group data set, to each the assumption record and each the conclusion record. Here, the assumption anonymous group data set is a data set which is generated by anonymizing a plurality of assumption records each of which makes a set with each of the conclusion record included in the conclusion anonymous group data set.

===Anonymization Information Storage Unit 600===

The anonymization information storage unit 600 stores the anonymous group data set, which the anonymization device 100 outputs and which includes the assumption anonymous group data set and the conclusion anonymous group data set.

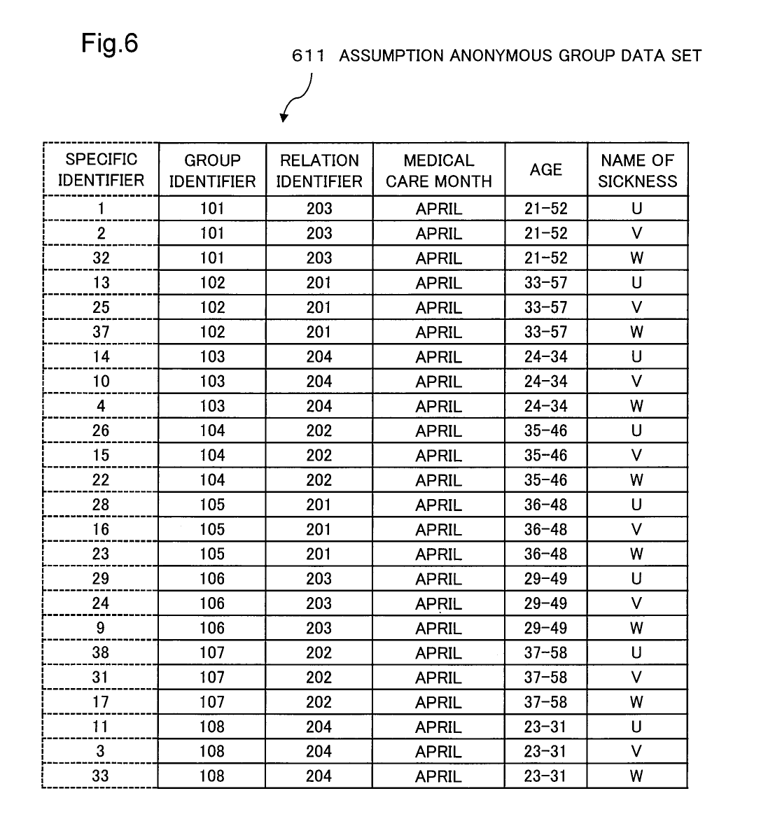

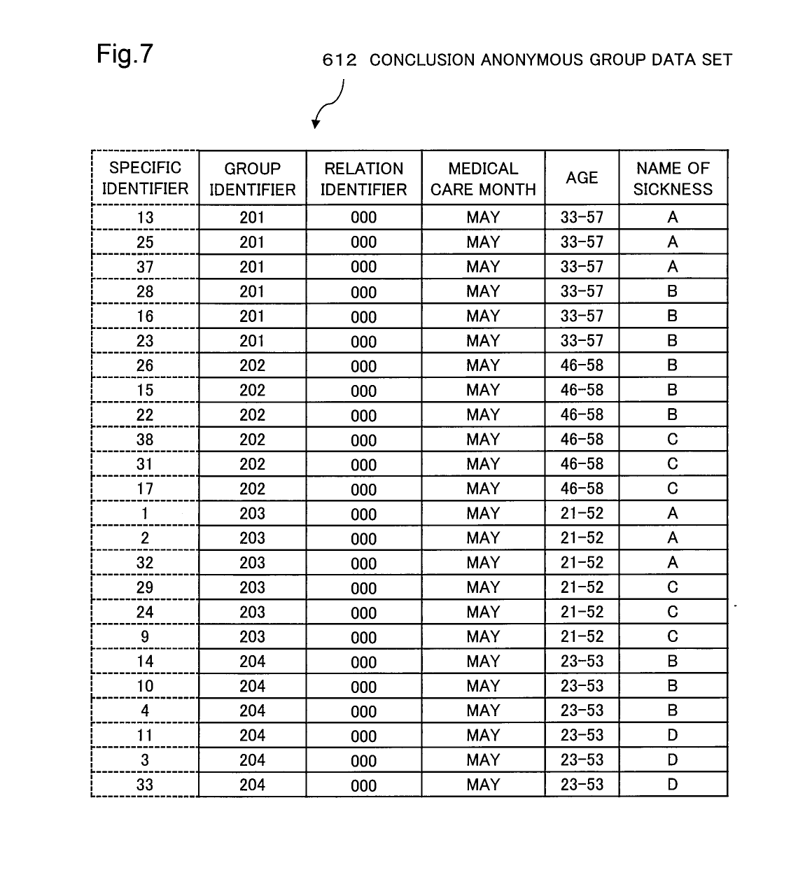

FIG. 6 is a diagram showing an example of an assumption anonymous group data set 611. FIG. 7 is a diagram showing an example of a conclusion anonymous group data set 612.

As shown in FIG. 6 and FIG. 7, each of the assumption anonymous group data set 611 and the conclusion anonymous group data set 612 includes a group identifier and a relation identifier in place of the specific identifier. Here, in FIG. 6, the specific identifier, which is written in a dotted line frame, is described so that it may be easy to understand a relationship between each record of the assumption record portion 521 and each record of the assumption anonymous group data set 611. Accordingly, the specific identifier is not included in the assumption anonymous group data set 611. Here, similarly, the specific identifier, which is written in a dotted line frame in FIG. 7, is not included in the conclusion anonymous group data set 612.

The group identifier is an identifier which is assigned commonly each of plural assumption records included in a certain assumption anonymous group. Similarly, the group identifier is an identifier which is assigned commonly each of plural conclusion records included in a certain conclusion anonymous group. The relation identifier is a group identifier which is assigned to another record having the same specific identifier. That is, a plurality of assumption records which are corresponding to the same group identifier form one assumption anonymous group. Similarly, a plurality of conclusion records which are corresponding to the same group identifier form one conclusion anonymous group.

Here, each record of the assumption anonymous group data set 611 and the conclusion anonymous group data set 612 may include the specific identifier. In this case, the anonymization information storage unit 600 may delete the specific identifier from the record and output the assumption anonymous group data set 611 and the conclusion anonymous group data set 612 in response to a request for acquiring the assumption anonymous group data set 611 and the conclusion anonymous group data set 612 which is issued from the outside.

The above is explanation on the anonymization device 100.

Next, each component of the anonymization device 100 will be explained in detail. Here, the component shown in FIG. 1 may be a component in a unit of hardware, or a component in a unit of function which a computer device has. In FIG. 1, the component will be explained as a component which is obtained by division per the unit of function of the computer device.

===Record Extraction Unit 110===

The record extraction unit 110 generates a transition vector. For example, the transition vector is a vector whose element is appearance frequency per an attribute value of a first attribute (hereinafter, called assumption attribute) which is included in the assumption record, that each attribute value of a second attribute (hereinafter, called conclusion attribute) included in a conclusion record appears in the conclusion record which makes a set with the assumption record. In other words, the transition vector is a vector whose element is the appearance frequency of each attribute value of a conclusion attribute per an attribute value of an assumption attribute. Here, the assumption attribute is the first attribute which is included in the assumption record. Moreover, the conclusion attribute is the second attribute which is included in the conclusion record. The appearance frequency makes a set with a frequency assumption record which, in the case that each attribute value of a conclusion attribute appears in the conclusion record which makes a set with an assumption record.

Specifically, the record extraction unit 110 calculates the transition vector with reference to the assumption record portion 521 shown in FIG. 4 and the conclusion record portion 522 shown in FIG. 5 as follows

The assumption attribute included in the assumption record is a sickness name which is the assumption attribute of the assumption record of the assumption record portion 521 shown in FIG. 4. Moreover, the conclusion attribute included in the conclusion record is a sickness name which is the attribute of the record of the conclusion record portion 522 shown in FIG. 5.

For example, assumption records, each of which includes an attribute value ‘U’ of the sickness name, are records of the assumption record group whose specific identifiers are ‘1’, ‘13’, ‘27’, ‘39’, ‘14’, ‘26’, ‘28’, ‘29’, ‘38’, ‘11’ and ‘12’. Conclusion records, each of which makes a set with the assumption record are conclusion records which have the same identifiers of ‘1’, ‘13’, ‘27’, ‘39’, ‘14’, ‘26’, ‘28’, ‘29’, ‘38’, ‘11’ and ‘12’.

Next, the record extraction unit 110 calculates the appearance frequency of attribute value that an attribute value appears as the attribute of the sickness name included in the conclusion record. In this case, an attribute value ‘A’ appears 4 times, and an attribute value ‘B’ appears 3 times, and an attribute value ‘C’ appears 2 times, and an attribute value ‘D’ appears 2 times, Accordingly, the appearance frequency is 0.37 (=4/11) in the case of ‘A’, and 0.28 (=3/11) in the case of ‘B’, and 0.19 (=2/11) in the case of ‘C’, and 0.19 (=2/11) in the case of ‘D’. Moreover, attribute values ‘E’ and ‘F’ of the attribute of the sickness name included in the conclusion record do not appear in the conclusion record which makes a set with the assumption record including the attribute value ‘U’ of the sickness name. Accordingly each appearance frequency in the case of ‘E’ and ‘F’ is ‘0’.

By the above, the record extraction unit 110 generates a transition vector tr_{U} regarding the attribute value ‘U’.
tr_{U}=(0.37, 0.28, 0.19, 0.19, 0.00, 0.00)^{T}

Similarly, the record extraction unit 110 generates transition vectors tr_{V}, tr_{W}, tr_{X}, tr_{Y} and tr_{Z} regarding the attribute values ‘V’, ‘W’, ‘X’, ‘Y’ and ‘Z’ respectively.
tr_{V}=(0.22, 0.44, 0.22, 0.11, 0.00, 0.00)^{T}
tr_{W}=(0.22, 0.33, 0.33, 0.11, 0.00, 0.00)^{T}
tr_{X}=(0.20, 0.20.0.00, 0.20, 0.40.0.00)^{T}
tr_{Y}=(0.00, 0.00, 0.00, 0.67, 0.33, 0.00)^{T}
tr_{Z}=(0.00, 0.00, 0.00, 0.67, 0.00, 1.00)^{T}

Next, the record extraction unit 110 calculates a level of similarity between the transition vectors. In the case that any two transition vectors out of the transition vectors can satisfy the second l-diversity in the conclusion record group, the record extraction unit 110 calculates the scalar product of the two transition vectors as the level of similarity between the two transition vectors. Here, the record extraction unit 110 may calculate, for example, the Euclid distance or the like as a distance in place of the scalar product as far as a level of similarity expressing similarity between vectors, or a distance expressing a level of non-similarity between vectors is calculated. Moreover, in the case that any two transition vectors out of the transition vectors cannot satisfy the second l-diversity in the conclusion record group, the record extraction unit 110 sets the level of similarity between the two vectors to be ‘0’.

Here, that ‘two transition vectors can satisfy the second l-diversity in the conclusion group’ means that l or more kinds (l of l-diversity: for example, 2 kinds) of conclusion attribute value of the conclusion attribute of the conclusion records, which are corresponding to the two transition vectors, are co-occurring. That is, it means that l or more kinds (l of l-diversity: for example, 2 kinds) of conclusion attribute value of the same conclusion attribute, which each of the conclusion records corresponding to the two transition vectors has, exist together.

Specifically, the record extraction unit 110 calculates a level of similarity sim (U, V) between the transition vector tr_{U} and the transition vector tr_{V}, and finds out that sim (U, V) is ‘0.26’ which is the scalar product of the transition vector tr_{U} and the transition vector tr_{V}. Similarly, the record extraction unit 110 calculates another level of similarity as follows.
sim(U, W)=0.25
sim(U, X)=0.16
sim(U, Y)=0.12
sim(U, Z)=0.00
sim(V, W)=0.28
sim(V, X)=0.16
sim(V, Y)=0.07
sim(V, Z)=0.00
sim(W, X)=0.13
sim(W, Y)=0.07
sim(W, Z)=0.00
sim(X, Y)=0.27
sim(X, Z)=0.00
sim(Y, Z)=0.00

Next, the record extraction unit 110 extracts the assumption record having the assumption attribute values which are corresponding to the transition vectors whose number is number of kinds of the first l-diversity, and the conclusion record, which makes a set with the assumption record, in a largeness order of a level of similarity (that is, in an smallness order of a level of abstraction). Here, ‘to correspond to the transition vectors whose number is number of kinds of the first l-diversity’ is sometimes referred to as ‘being able to satisfy the first l-diversity in the assumption record group (first record group including the first record which makes a set with the second record)’.

Moreover, the record extraction unit 110 may extract only the conclusion record mentioned above. In this case, the record extraction unit 110 may refer to the assumption record of the data set 510 in the following process on the basis of the specific identifier of the extracted conclusion record

Specifically, the record extraction unit 110 extracts a set of the assumption record and the conclusion record as follows. The set of the assumption record and the conclusion record may be extracted so that a level of abstraction may be low, and an extraction order is optional.

Here, an example of extracting a set of the assumption record and the conclusion record will be shown. Total values of the level of similarity regarding the assumption attribute values ‘U’, ‘V’, ‘W’, ‘X’ and ‘Y’ are ‘0.80’, ‘0.78’, ‘0.74’, ‘0.72’ and ‘0.54’ respectively. Then, the record extraction unit 110 selects the transition vector tr_{U} which is corresponding to the assumption attribute value ‘U’ and has the maximum total value of the level of similarity Next, the record extraction unit 110 selects the transition vector tr_{V} and the transition vector tr_{W} in the largeness order of the level of similarity to the transition vector tr_{U}.

Conclusion records, each of which makes a set with each of the assumption records corresponding to the above-mentioned vectors, are records whose specific identifiers are ‘1’, ‘13’, ‘27’, ‘39’, ‘14’, ‘26’, ‘28’, ‘29’, ‘38’ ‘11’, ‘12’, ‘2’, ‘25’, ‘10’, ‘15’, ‘16’, ‘30’, ‘24’, ‘31’, ‘3’, ‘32’, ‘37’, ‘4’, ‘22’, ‘23’, ‘9’, ‘17’, ‘36’ and ‘33’. The record extraction unit 110 extracts these records.

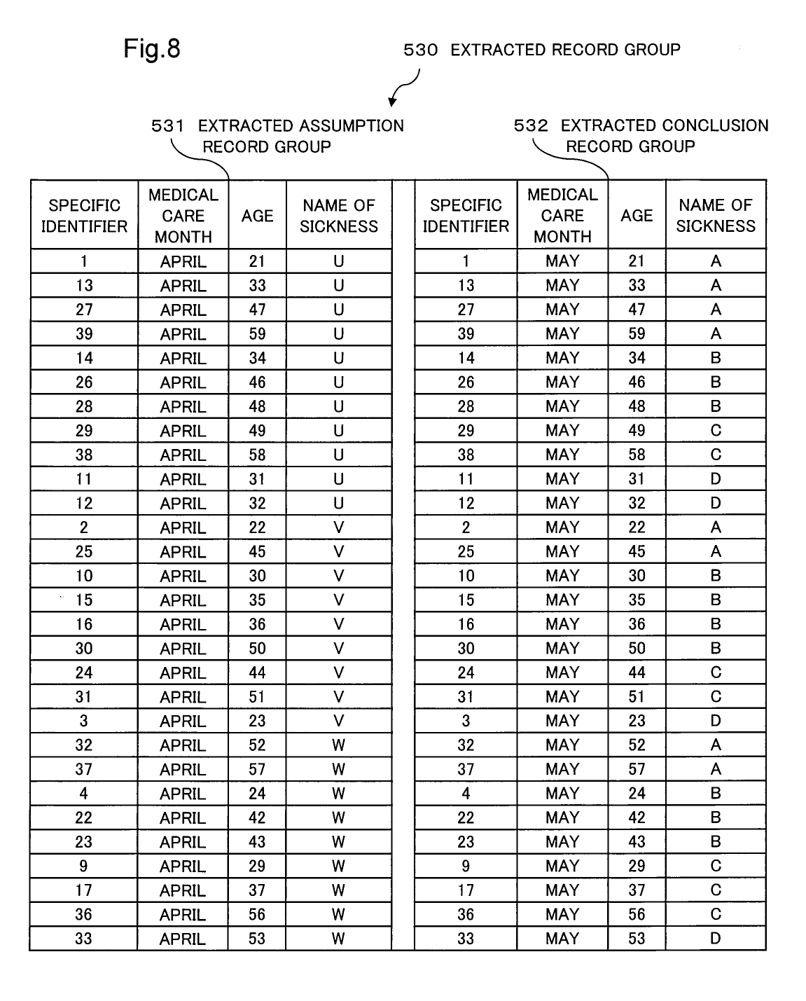

FIG. 8 is a diagram showing an example of an extracted record group 530 which the record extraction unit 110 extracts as mentioned above. FIG. 8 shows the extracted record group 530 as records of the assumption record and the conclusion record which make a set and which are included in an extracted assumption record group 531 and an extracted conclusion record group 532 respectively.

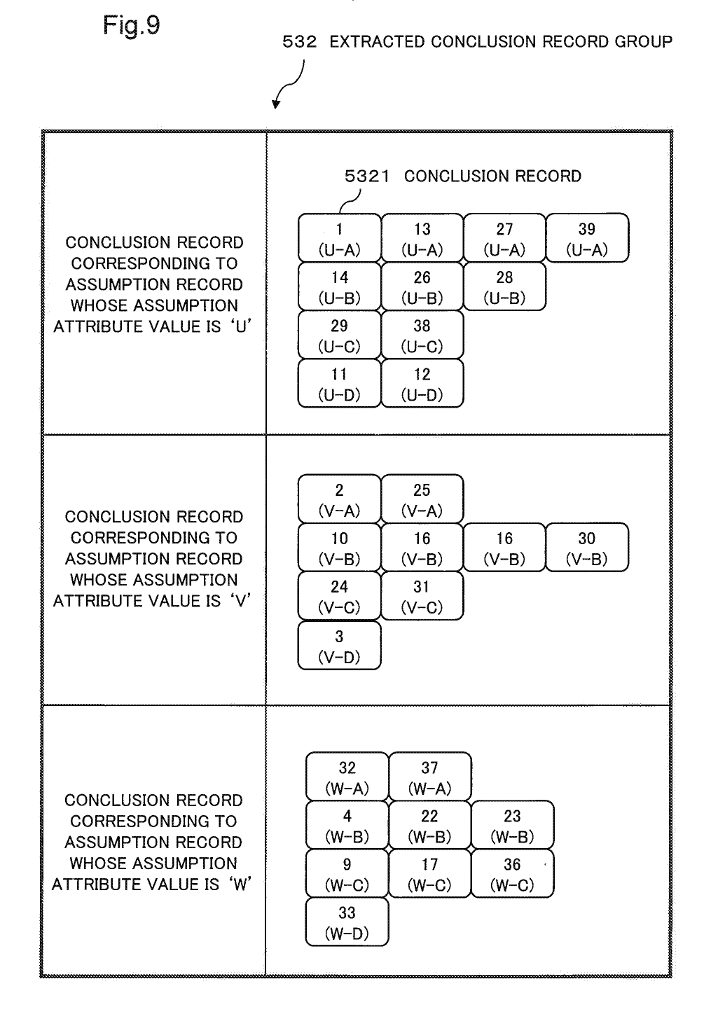

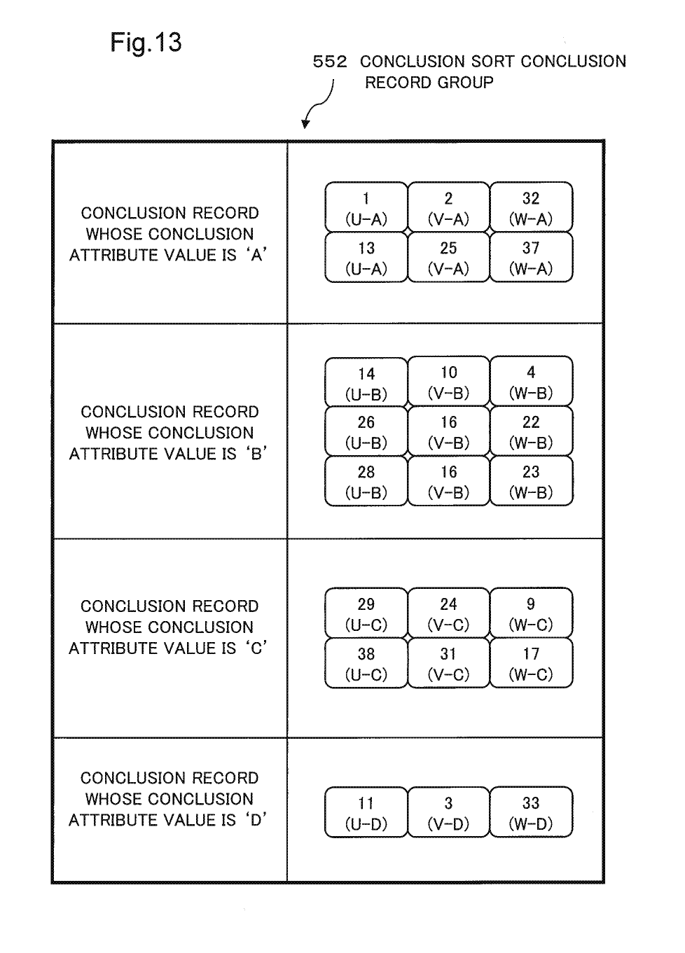

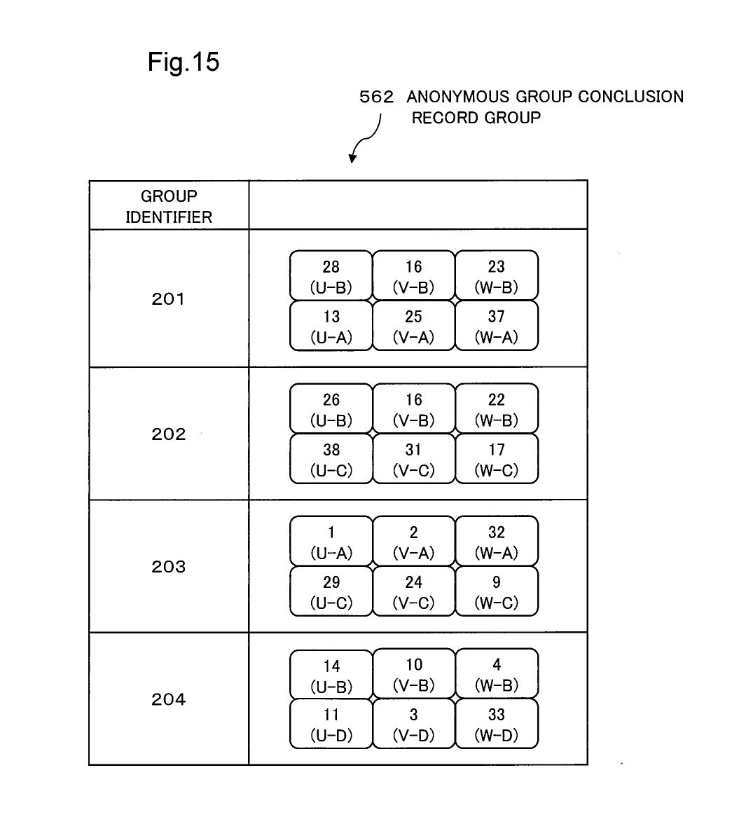

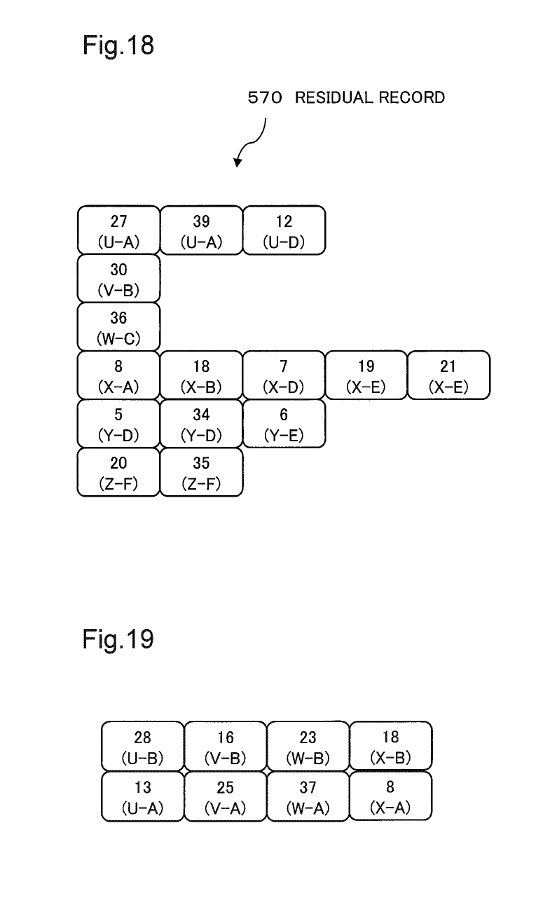

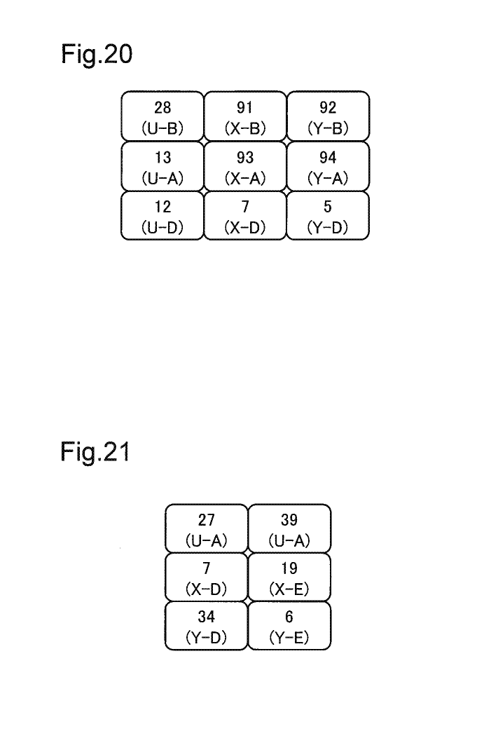

FIG. 9 is a diagram showing an example of the extracted conclusion record group 532 which is generated by sorting the conclusion record per the assumption record having the same assumption attribute value from the extracted record group 530 shown in FIG. 8. Here, in FIG. 9, an upper side of a conclusion record 5321 indicates the specific identifier (for example, ‘1’), and a lower side indicates the assumption attribute value and the conclusion attribute value (for example, ‘U-A’). The notation is similar also in FIG. 11, FIG. 13, FIG. 15, FIG. 18, FIG. 19, FIG. 20 and FIG. 21

As shown in FIG. 9, the conclusion records corresponding to the assumption record, whose assumption attribute value is ‘U’, have the specific identifiers ‘1’, ‘13’, ‘27’, ‘39’, ‘14’, ‘26’, ‘28’, ‘29’, ‘38’ ‘11’ and ‘12’.

===Anonymous Group Generation Unit 120===

The anonymous group generation unit 120 extract a set of the assumption record and the conclusion record per the assumption record, which has the same assumption attribute value, from the extracted record group 530. When carrying out extraction, the anonymous group generation unit 120 extracts a set of the assumption record and the conclusion record so that number of conclusion records, each of which has the same conclusion attribute value and which are corresponding to the assumption records each having the same attribute value, may become common. That is, per the assumption record which has the same assumption attribute value, the anonymous group generation unit 120 extracts sets of the assumption record and the conclusion record whose number is equal to the minimum value of the number of conclusion records, each of which has the same conclusion attribute value and which are corresponding to the assumption records each of which has the same assumption attribute value.

The anonymous group generation unit 120 may extract only the conclusion record mentioned above. In this case, in the following process, the anonymous group generation unit 120 may refer to the assumption record of the data set 510 on the basis of the specific identifier of the extracted conclusion record.

For example, the anonymous group generation unit 120 judges that the minimum value is 2 by comparing number of the conclusion records which have the conclusion attribute value ‘A’ and the corresponding assumption attribute value ‘U’, ‘V’ or ‘W’.

On the basis that the minimum value is 2, the anonymous group generation unit 120 extracts two sets of the assumption record and the conclusion record per the assumption record which has the same assumption attribute value. For example, sets of the assumption record whose assumption attribute value is ‘U’, and the conclusion record which has the conclusion attribute value ‘A’ corresponding to the assumption record are sets of the assumption record and the conclusion record whose specific identifiers are ‘1’, ‘13’, ‘27’ and ‘39’. Then, the anonymous group generation unit 120 extracts, for example, sets of the assumption record and the conclusion record whose identifiers are ‘1’ and ‘13’.

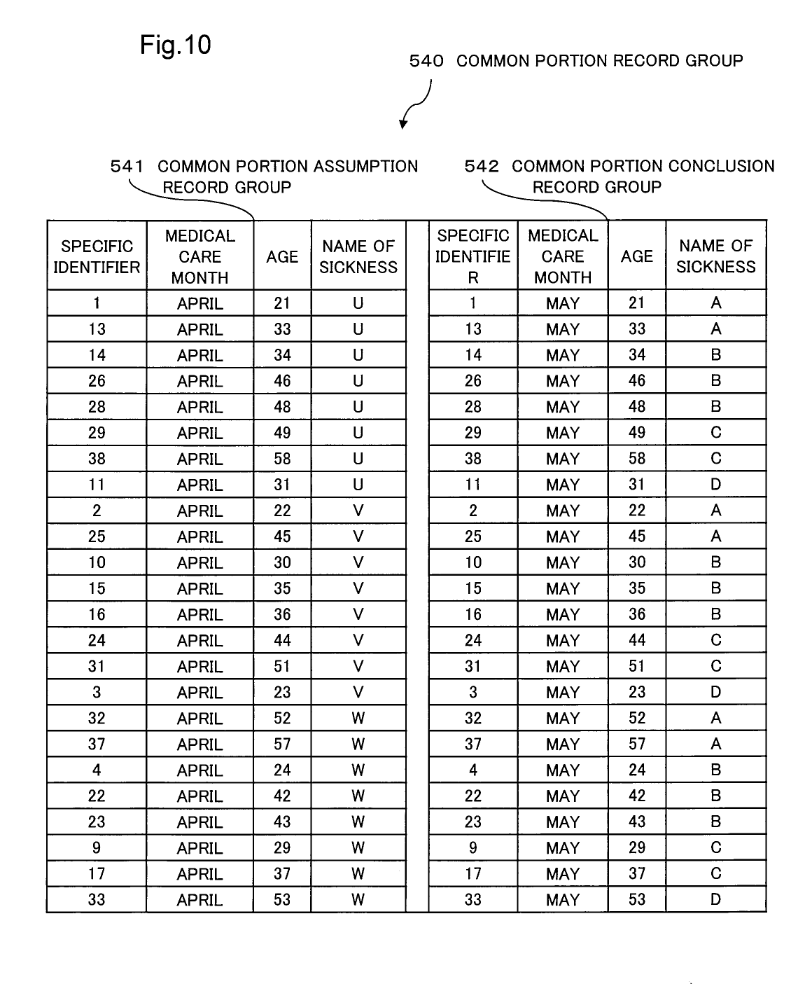

FIG. 10 shows an example of a common portion record group 540 as records of the assumption record and the conclusion record which make a set and which are included in a common portion assumption record group 541 and a common portion conclusion record group 542 respectively. The common portion record group 540 includes a set of the assumption record and the conclusion record which are extracted from the extracted record group 530 shown in FIG. 8. Here, per the assumption record which has the same assumption attribute value, the assumption record and the conclusion record are extracted so that the conclusion record group, which is corresponding to the assumption records each having the same assumption attribute, may become common. That is, the common portion record group 540 includes the assumption record and the conclusion record, which are extracted as mentioned above, as the common portion assumption record group 541 and the common portion conclusion record group 542

FIG. 11 is a diagram showing an example of the common portion conclusion record group 542, which is generated by collecting the conclusion record per the assumption record having the same assumption attribute value from the common portion record group 540 shown in FIG. 10.

As shown in FIG. 11, each number of conclusion records, whose conclusion attribute value is ‘A’ and which are corresponding to the assumption records having the assumption attribute values ‘U’, ‘V’ and ‘W’, is 2.

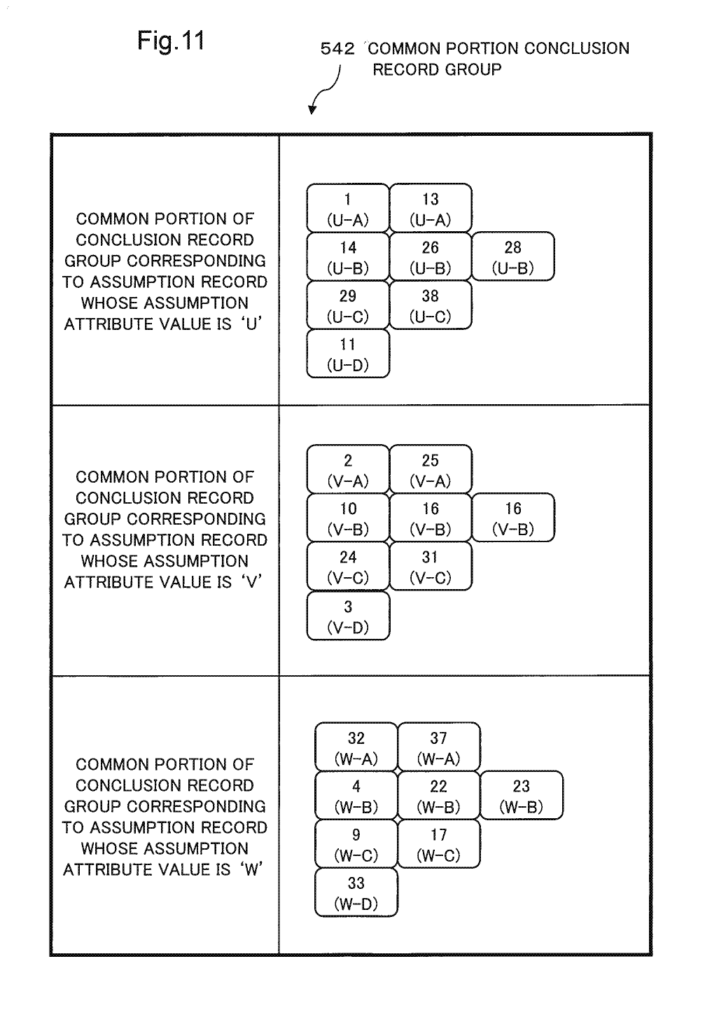

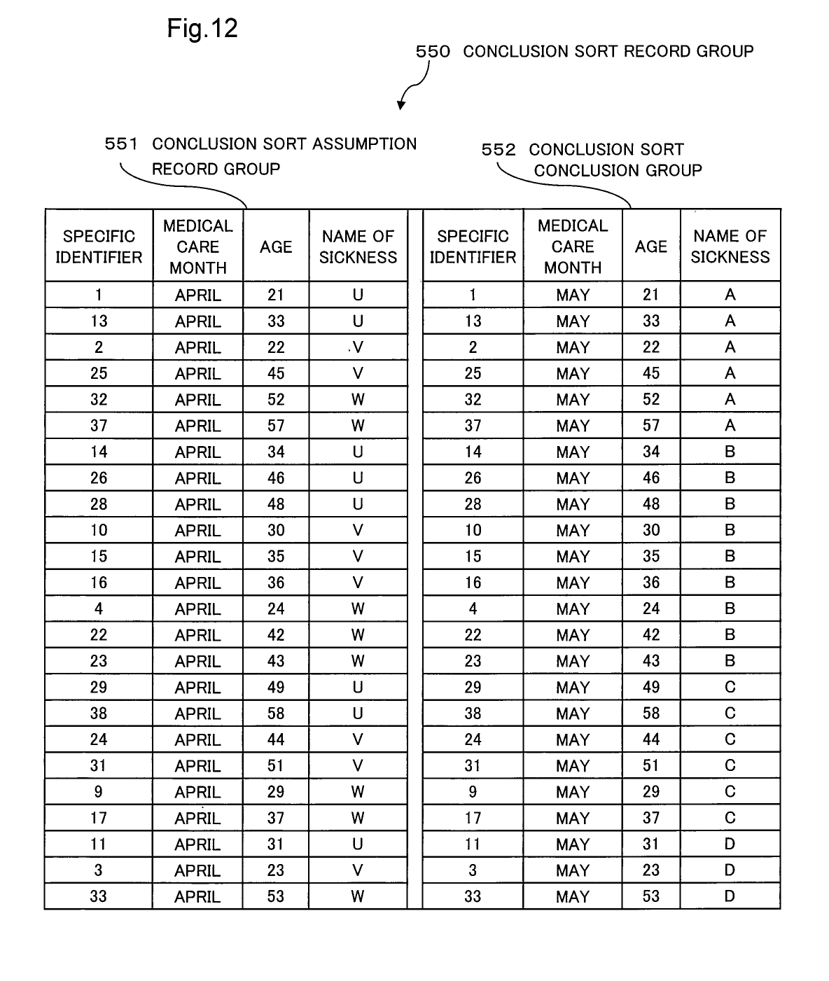

FIG. 12 is a diagram showing a state that the common portion record group 540 is sorted according to the conclusion attribute of the common part assumption record group 541 as a conclusion sort record group 550. The conclusion sort record group 550 shown in FIG. 12 is not generated by the anonymization device 100. FIG. 12 is a diagram used for convenience of explanation. FIG. 12 shows the conclusion sort record group 550 (the common portion record group 540), which is in a state of being sorted according to the conclusion attribute, as records of the assumption record and the conclusion record which make a set and which are included in a conclusion sort assumption record group 551 and a conclusion sort conclusion record group 552 respectively.

FIG. 13 is a diagram showing an example of the conclusion sort conclusion record group 552 (the common portion conclusion record group 542), which is generated by collecting the conclusion records each having the same conclusion value, like the common portion conclusion record group 542 shown in FIG. 10 is sorted into the conclusion sort conclusion record group 552 shown in FIG. 12.

As shown in FIG. 13, the conclusion records, each of which has the conclusion attribute values ‘A’, form two combinations (herein after, called combination C) corresponding to the assumption records whose assumption attribute value are ‘U, ‘V’ and ‘W respectively. One out of the two combinations C is a combination of records whose specific identifiers are ‘1’, ‘2’ and ‘32’, and the other is a combination of records whose identifiers are ‘13’, ‘25’ and ‘37’. Here, the combination C may be any combination as far as the combination is corresponding to the assumption records whose assumption attribute values are ‘U, ‘V’ and ‘W respectively. That is, the combination C is a combination corresponding to the assumption records which satisfy the first l-diversity.

Next, by use of the common portion conclusion record group 542, the anonymous group generation unit 120 generates an anonymous group conclusion record group 562 including conclusion records which is classified into a conclusion anonymous group satisfying the second l-diversity.

For example, the anonymous group generation unit 120 selects the combination C regarding the conclusion attribute value ‘B’, and the combination C regarding the conclusion attribute value ‘A’ to generate the conclusion anonymous group, and assigns the generated conclusion anonymous group the group identifier (for example, ‘201’). In this case, the anonymous group generation unit 120 may select the combination C so that residual number of the combination C may become as even as possible per the conclusion attribute value.

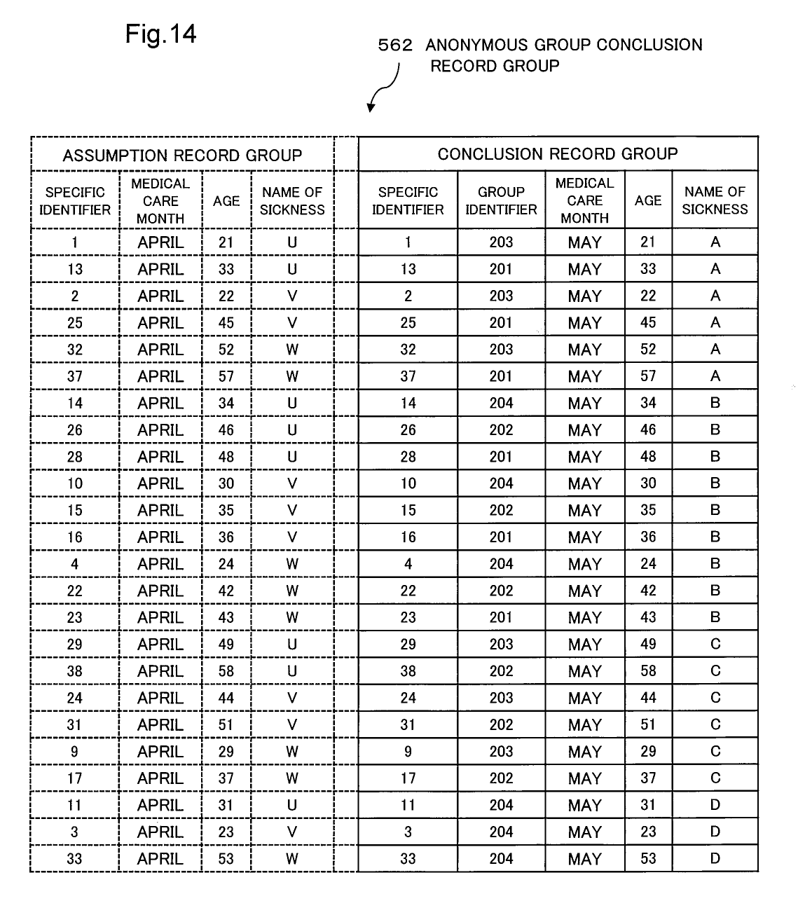

FIG. 14 is a diagram showing an example of the anonymous group conclusion record group 562 which is generated by use of the common portion conclusion record group 542. Here, the assumption record group, which is written in a dotted line frame shown in FIG. 14, is described so that the relationship between the conclusion record and the assumption record may be understood easily the assumption record group is not included in the anonymous group conclusion record group 562.

FIG. 15 is a diagram showing an example of the anonymous group conclusion record group 562 which is generated by collecting the conclusion record per the group identifier from the anonymous group conclusion record group 562 shown in FIG. 14.

Next, the anonymous group generation unit 120 generalizes (convert into the same value) an attribute value of a quasi-identifier (in this case, attribute value of age) other than conclusion attributes per each group (a set of conclusion records each having the same group identifier) of the anonymous group conclusion record group 562 to generate the conclusion anonymous group data set 612 shown in FIG. 7, and outputs the generated conclusion anonymous group data set 612 as a conclusion anonymous data set (second anonymous group data set). Here, while the conclusion anonymous group data set 612 shown in FIG. 7 is sorted according to the group identifier, the conclusion record of the conclusion anonymous data set, which the anonymous group generation unit 120 outputs, may be listed in any order.

Here, in the case that it is unnecessary to generalize a attribute value of a quasi-identifier (in this case, attribute values of medical care month and age) other than the conclusion attribute, for example, in the case of, the conclusion record not including those attributes, the anonymous group generation unit 120 may output the anonymous group conclusion record group 562 as the conclusion anonymous group data set.

The above is explanation on generation of the conclusion anonymous group data set which includes the conclusion records.

Next, generation of an assumption anonymous group data set which includes assumption records will be explained. Here, a method for generating the assumption anonymous group data set is not limited to the following method. The assumption anonymous group data set may be generated by another anonymization device or another method.

The anonymous group generation unit 120 generates the assumption anonymous group data set 611 shown in FIG. 6 by use of the common portion assumption record group 541 shown in FIG. 10, and outputs the generated assumption anonymous group data set 611.

Specifically, the anonymous group generation unit 120 extracts a combination of the assumption records corresponding to the assumption attribute values, whose number is corresponding to the number of kinds regarding the first l-diversity (for example, the combination of the assumption records whose specific identifiers are ‘1’, ‘2’ and ‘32’), in turn from a head of the common portion assumption record group 541. Then, the anonymous group generation unit 120 assigns each of the extracted combinations the group identifier (for example, ‘101’). That is, each of the extracted combinations forms an assumption anonymous group.

Next, the anonymous group generation unit 120 generalizes (convert into the same value) a attribute value of a quasi-identifier (in this case, attribute value of age), which is not the assumption attribute and which each assumption record holding the assigned group identifier has.

Furthermore, the anonymous group generation unit 120 sets the group identifier of the conclusion records, each of which has the same specific identifier, as the relation identifier, and generates the assumption anonymous group data set 611 shown in FIG. 6.

The above is explanation on generation of the assumption anonymous group data set which includes the assumption record.

The above is explanation on each component in the unit of function of the anonymization device 100.

Next, a component of a hardware unit of the anonymization device 100 will be described.

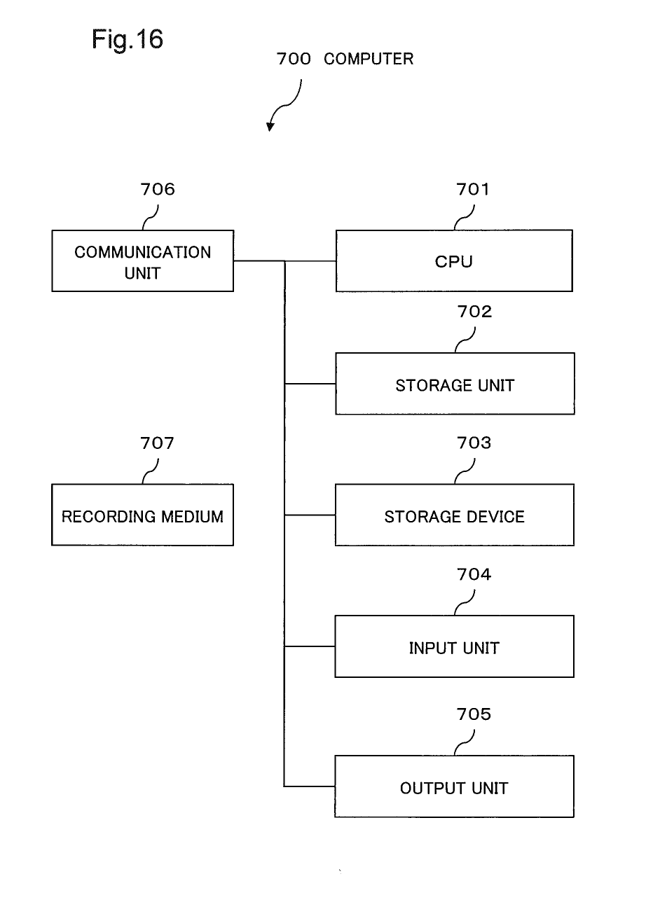

FIG. 16 is a diagram illustrating a hardware configuration of a computer 700 for implementing the anonymization device 100 according to this exemplary embodiment.

As illustrated in FIG. 16, the computer 700 includes a CPU (Central Processing Unit) 701, a storage unit 702, a storage device 703, an input unit 704, an output unit 705, and a communication unit 706. In addition, the computer 700 includes a recording medium (or a storage medium) 707 provided externally. The recording medium 707 may be a nonvolatile recording medium storing information non-temporarily.

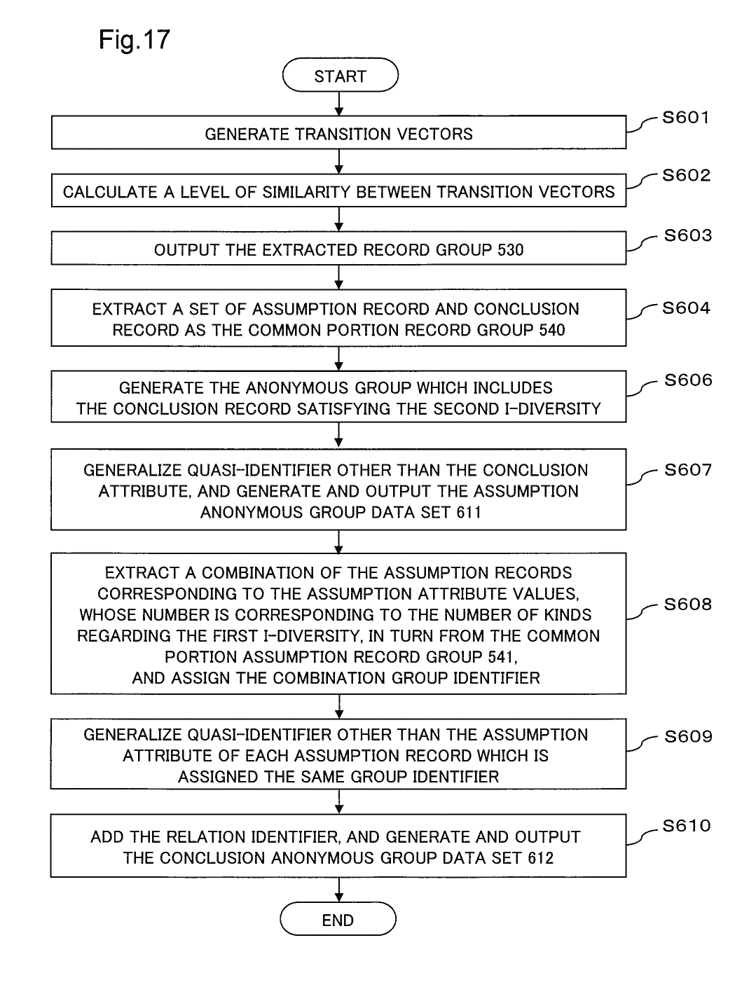

The CPU 701 controls the entire operation of the computer 700 by causing the operating system (not illustrated) to operate. In addition, the CPU 701 loads a program or data from the recording medium 707 supplied to the storage device 703, for example, and writes the loaded program or data in the storage unit 702. Here, the program is, for example, a program for causing the computer 700 to perform the operations in the flowcharts presented in FIG. 17 to be described later.

Then, the CPU 701 carries out various processes as the processing unit 120 presented in FIG. 1, according to the loaded program or on the basis of the loaded data.

Alternatively, the CPU 701 may be configured to download a program or data from an external computer (not illustrated) connected to a communication network (not illustrated), to the storage unit 702.

The storage unit 702 stores programs and data. The storage unit 702 may store the data set 510, extracted record group 530, common portion record group 540, anonymous group conclusion record group 562, assumption anonymous group data set 611 and conclusion anonymous group data set 612. The storage unit 702 may include the history information storage unit 500 and the anonymization information storage unit 600.

For example, the storage device 703 is an optical disc, a flexible disc, a magnetic optical disc, an external hard disk, or a semiconductor memory, and includes a non-volatile recording medium 707. The storage device 703 records a program so that it is computer-readable. The storage device 703 may record data. The storage device 703 may store the data set 510, extracted record group 530, common portion record group 540, anonymous group conclusion record group 562, assumption anonymous group data set 611 and conclusion anonymous group data set 612. The storage device 703 may include the history information storage unit 500 and the anonymization information storage unit 600.

The input unit 704 is realized by a mouse, a keyboard, or a built-in key button, for example, and used for an input operation. The input unit 704 is not limited to a mouse, a keyboard, or a built-in key button, it may be a touch panel, an accelerometer, a gyro sensor, or a camera, for example.

The output unit 705 is realized by a display, for example, and is used in order to check the disclosure response 650, for example.

The communication unit 706 realizes communication with an external device. The communication unit 706 may be included in the record extraction unit 110 and anonymous group generation unit 120 as a part of each of them.

As described above, the blocks serving as functional units of the anonymization device 100 illustrated in FIG. 1 may be implemented by the computer 700 having the hardware configuration illustrated in FIG. 16. However, means for implementing the units included in the computer 700 are not limited to those described above. In other words, the computer 700 may be implemented by a single physically-integrated device, or may be implemented by two or more physically-separated devices that are connected to each other with wire or by wireless.

Instead, the recording medium 707 with the codes of the above-described programs recorded therein may be provided to the computer 700, and the CPU 701 may be configured to load and then execute the codes of the programs stored in the recording medium 707. Alternatively, the CPU 701 may be configured to store the codes of each program stored in the recording medium 707, in the storage unit 702, the storage device 703, or both. In other words, this exemplary embodiment includes an exemplary embodiment of the recording medium 707 for storing programs (software) to be executed by the computer 700 (CPU 701) in a transitory or non-transitory manner.

The above is the description of hardware about each component of the computer 700 which realizes the anonymization device 100.

Next, an operation of the exemplary embodiment will be explained in detail with reference to FIG. 1 to FIG. 17.

FIG. 17 is a flowchart showing the operation of the exemplary embodiment. Here, a process according to the flowchart may be executed by CPU on the basis of the above-mentioned program control. Moreover, a step name of the process is denoted, for example, as S601 by use of a code.

The record extraction unit 110 generates transition vectors (S601).

Next, the record extraction unit 110 calculates a level of similarity between the transition vectors (S602).

Next, the record extraction unit 110 extracts an assumption records which have assumption attribute values corresponding to the transition vectors whose number is a number of kinds regarding a first l-diversity, and a conclusion records each of which makes a set with the assumption record, in a largess order of a level of similarity which the transition vector has, and outputs the extracted assumption record and the extracted conclusion record as the extracted record group 530 (S603).

Next, the anonymous group generation unit 120 extracts a set of the assumption record and the conclusion record from the extracted record group 530 as the common portion record group 540 so that number of the conclusion records, which are corresponding to the assumption records and each of which has the same conclusion attribute value, may become common per the assumption record which has the same assumption attribute value (S604).

Next, the anonymous group generation unit 120 generates the anonymous group conclusion record group 562 including the conclusion record, which is classified into the conclusion anonymous group satisfying the second l-diversity, by use of the common portion conclusion record group 542 (S606).

Next, the anonymous group generation unit 120 generalizes an attribute value of a quasi-identifier other than the conclusion attribute per the group of the anonymous group conclusion record group 562, and generates the conclusion anonymous group data set 612, and outputs the generated conclusion anonymous group data set 612 as the conclusion anonymous group (S607).

Next, the anonymous group generation unit 120 carries out grouping the assumption records. The anonymous group generation unit 120 extracts a combination of the assumption records corresponding to the assumption attribute values, whose number is corresponding to the number of kinds regarding the first l-diversity, in turn from a head of the common portion assumption record group 541 and assigns each of the extracted combinations the group identifier (S608).

However, a method for grouping the assumption record is not limited to the above-mentioned method, and various methods may be applied. For example, after the current assumption record is set as a conclusion record, and another record group is set as assumption records, the new assumption record may be grouped.

Next, the anonymous group generation unit 120 generalizes an attribute value of a quasi-identifier which is not the assumption attribute and which each assumption record holding the assigned same group identifier has (S609).

Next, the anonymous group generation unit 120 sets the group identifier of the conclusion records, each of which has the same specific identifier, as the relation identifier and generates the assumption anonymous group data set 611, and outputs the generated assumption anonymous group data set 611 (S610)

### First Modification of the Exemplary Embodiment

The anonymous group generation unit 120 adds residual records, which can be added so as to avoid abstracting the correspondence relationship, to the assumption anonymous group data set (first anonymous group data set) and the conclusion anonymous group data set (second anonymous group data set). Here, the residual record is a conclusion record having a specific identifier other than the specific identifier which the conclusion record of the conclusion anonymous group data set has.

A specific example will be explained in the following with reference to a drawing.

FIG. 18 is a diagram showing an example of residual record 570 which is generated by removing the conclusion anonymous group data set 612 shown in FIG. 7 from the conclusion record portion 522 shown in FIG. 5.

The anonymous group generation unit 120 adds a plurality of sets of a assumption record and a conclusion record, which satisfy the following condition, to a specific conclusion anonymous group. A first condition is that each of the plural assumption records has the same assumption attribute value different from any assumption attribute value of the assumption record which makes a set with the conclusion record included in the specific conclusion anonymous group. A second condition is that the plural conclusion records include all kinds of assumption attribute value of each assumption record included in the specific conclusion anonymous group.

For example, the anonymous group generation unit 120 selects a group, whose group identifier is ‘201’, as the specific conclusion anonymous group after Step S606 shown in FIG. 17.

Furthermore, the anonymous group generation unit 120 extracts conclusion records which are corresponding to an assumption attribute value other than the assumption attribute values ‘U’, ‘V’ and ‘W’ and which have the conclusion attribute values ‘A’ and ‘B’.

Next, the anonymous group generation unit 120 assigns the extracted conclusion record the group identifier ‘201’.

Next, the anonymous group generation unit 120 carries out Step S607 and steps following Step S607 shown in FIG. 7 with including the extracted conclusion record and the assumption record which is corresponding to the extracted conclusion record.

FIG. 19 is a diagram showing schematically an example of the conclusion anonymous group whose group identifier is ‘201’. As shown in FIG. 19, there are 8 kinds of correspondence relationship, which are shown per the specific identifier, before anonymization. Moreover, in the case that all of the conclusion records are grouped into a same group identifier, that is, in the case that it is possible to switch between a assumption attribute value and a conclusion attribute value, there are 8 kinds of correspondence relationship also in this case. That is, abstraction of the correspondence relationship is not caused.

Moreover, the anonymous group generation unit 120 may add plural sets of a assumption record and a conclusion record, which satisfy the following condition, to a specific conclusion anonymous group. A first condition is that each of the plural conclusion records has the same conclusion attribute value different from any conclusion attribute value of the conclusion record which is included in the specific conclusion anonymous group. A second condition is that each of the plural assumption records includes all kinds of assumption attribute value of each assumption record which is corresponding to the conclusion record included in the specific conclusion anonymous group.

FIG. 20 is a diagram showing schematically an example of the conclusion anonymous group which is generated on the basis of the above-mentioned condition.

### Second Modification of the Exemplary Embodiment

The anonymous group generation unit 120 generates an assumption anonymous group including a assumption record, and an conclusion anonymous group including a conclusion record, which can be anonymized by satisfying the first l-diversity and the second l-diversity respectively, from the residual records. Here, the residual record is the conclusion record having a specific identifier other than the specific identifier held by the conclusion record which is included in the conclusion anonymous group data set outputted in the process shown in FIG. 17.

FIG. 21 is a diagram showing an example of the conclusion anonymous group which is generated from the residual record 570. As shown in FIG. 21, the conclusion anonymous group, which is generated as mentioned above, satisfies the second l-diversity, and the anonymous group including the assumption record, which is corresponding to the conclusion record, satisfies the first l-diversity. However, while there are 5 kinds of correspondence relationship, which are shown per the specific identifier, before anonymization, there are 9 kinds of correspondence relationship after the grouping process. Accordingly, abstraction of the correspondence relationship is caused.

### Third Modification of the Exemplary Embodiment

According to the above explanation, the record extraction unit 110 and the anonymous group generation unit 120 carry out the process on the basis of a definition that the record, which has the attribute value ‘April’ of medical care month, is the assumption record (first record), and the record, which has the attribute value ‘May’ of medical care month, is the conclusion record (second record). However, the record extraction unit 110 and the anonymous group generation unit 120 may set the record, which has the attribute value ‘May’ of medical care month, as the assumption record (first record), and set the record, which has the attribute value ‘April’ of medical care month is ‘April’, as the conclusion record (second record).

That is, the correspondence relationship is not depending on physical characteristics of the attribute, and a direction of the correspondence relationship is optional.

### Fourth Modification of the Exemplary Embodiment

According to the above explanation, the record extraction unit 110 and the anonymous group generation unit 120 carry out extraction and selection of the record in each operation in an order, which is described in the drawing, in consideration of only the relation between the assumption attribute value and the conclusion attribute value However, the record extraction unit 110 and the anonymous group generation unit 120 may carry out extraction and selection (for example, grouping records each of which has an almost equal attribute value of age into the same group) of the record in each operation in consideration of anonymization of another attribute (for example, generalization of age).

### Fifth Modification of the Exemplary Embodiment

Each of the processes from Step S608 to Step 610 may be carried out at any timing after Step S604 under the condition of keeping an order of the processes.

### Sixth Modification of the Exemplary Embodiment

The anonymous group generation unit 120 may output the assumption anonymous group data set and the conclusion anonymous group data set separately, or may output one data set into which the assumption anonymous group data set and the conclusion anonymous group data set are united.

### Seventh Modification of the Exemplary Embodiment

The anonymous group generation unit 120 may associate the group identifier of the assumption record, which is corresponding to a conclusion record of a conclusion anonymous group data set, with the conclusion record of the conclusion anonymous group data set. In this case, the anonymous group generation unit 120 may not associate the relation identifier with the assumption record.

### Eighth Modification of the Exemplary Embodiment

The anonymous group generation unit 120 may make the group identifier of an assumption record of an assumption anonymous group which is corresponding to the conclusion anonymous group, and the group identifier of an conclusion record of an conclusion anonymous group, which is corresponding to the assumption anonymous group, identical each other. In this case, the anonymous group generation unit 120 may not associate the relation identifier with the assumption record and the conclusion record.

The exemplary embodiment has a first effect in a point that, in the case that a data set, which includes information on ‘correspondence relationships between the records each having the same specific identifier’, is anonymized so as to satisfy the l-diversity, it is possible to prevent that the information on correspondence relationship becomes too unclear.

The reason is that the exemplary embodiment has the following configuration. That is, firstly, the record extraction unit 110 extracts the assumption record and the conclusion record on the basis that it is possible to satisfy the first l-diversity and the second l-diversity and on the basis of the level of abstraction of the correspondence relationship. Secondly, by referring to the assumption record which is extracted by the record extraction unit 110, and extracting the conclusion record from the similarly-extracted conclusion records so as to satisfy the first l-diversity and the second l-diversity, the anonymous group generation unit 120 generates the conclusion anonymous group.

The exemplary embodiment has a second effect in a point that, also in the case that a data set, which includes information on ‘correspondence relationships between the records each having the same specific identifier’, is anonymized so as to satisfy the l-diversity whose values l for an assumption record and a conclusion record are different each other, it is possible to prevent that the information on correspondence relationship becomes too unclear.

The reason is the same as the reason of the first effect.

The exemplary embodiment has a third effect in a point that it is possible to use the record, which is included in the data set, more efficiently.

The reason is that the anonymous group generation unit 120 adds the residual record, which can be added so as to avoid abstracting the correspondence relationship, to the assumption anonymous group data set and the conclusion anonymous group data set.

The exemplary embodiment has a fourth effect in a point that it is possible to use the record, which is included in the data set, furthermore more efficiently.

The reason is that the anonymous group generation unit 120 generates the assumption anonymous group and the conclusion anonymous group respectively from the residual records.

The exemplary embodiment has a fifth effect in a point that it is possible to anonymize the data set so that a usage value may not be lowered.

The reason is that the record extraction unit 110 and the anonymous group generation unit 120 carry out extraction and selection of the record in each operation in consideration of anonymization of another attribute.

### Second Exemplary Embodiment

Next, a second exemplary embodiment of the present invention will be explained in detail with reference to a drawing. Contents which overlap with the above explanation are omitted within a scope that explanation of the exemplary embodiment does not become unclear.

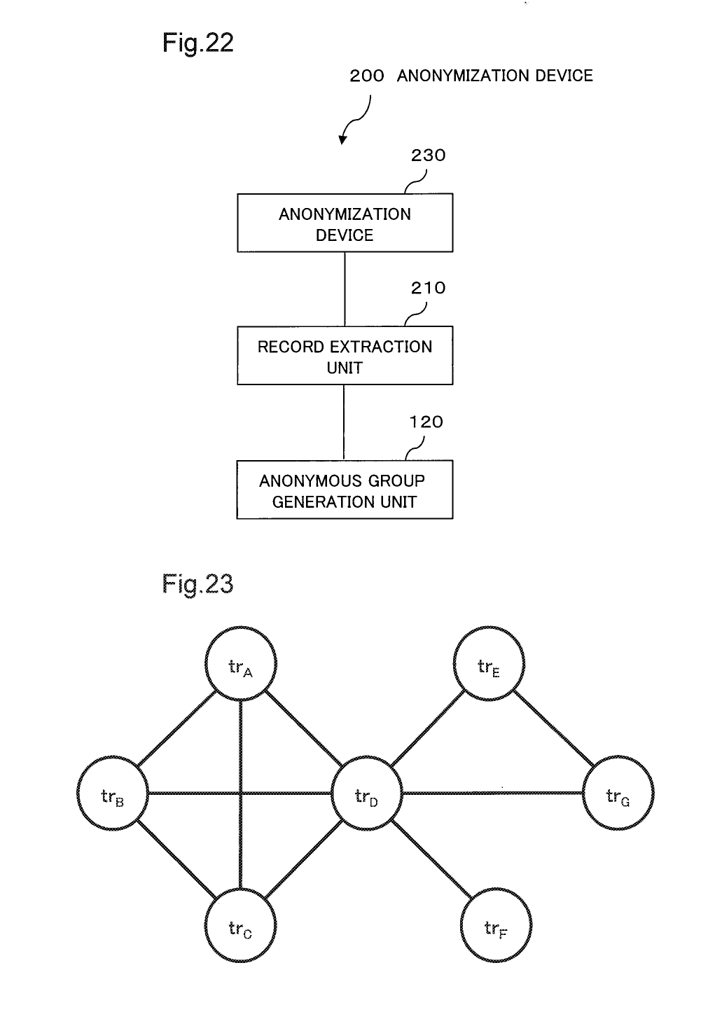

FIG. 22 is a block diagram showing an anonymization device 200 according to a second exemplary embodiment of the present invention.

A component shown in FIG. 22 is not a component shown in an unit of hardware, but a component shown in an unit of function. Here, the component shown in FIG. 22 may be the component shown in the unit of hardware or may be a component which is obtained by dividing a computer device in a unit of function. In the exemplary embodiment, the component shown in FIG. 22 is explained as the component which is obtained by dividing the computer device in the unit of function

With reference to FIG. 22, the anonymization device 200 according to the exemplary embodiment includes furthermore a transition vector extraction unit 230, and a record extraction unit 210 which replaces the record extraction unit 110 in comparison with the anonymization device 100 according to the first exemplary embodiment.

===Transition Vector Extraction Unit 230===

The transition vector extraction unit 230 generates calculation target information which indicates a target for calculating a level of similarity regarding a plurality of transition vectors. Then, the transition vector extraction unit 230 outputs the calculation target information to the record extraction unit 210.

Handling of extracting a calculation target which is included in calculation target information will be explained in detail in the following.

<<<First Extraction Handling>>>

In the case that there is a co-occurrence of l or more kinds of element regarding the second l-diversity between two transition vectors, the transition vector extraction unit 230 extracts a combination of the two transition vectors as the calculation target.

For example, it is assumed that l of the second l-diversity is ‘2’. Moreover, a plurality of transition vectors which are process targets of the transition vector extraction unit 230 are defined as follows.
tr_{A}=(0.3, 0.2, 0.2, 0.0, 0.0, 0.0, 0.0, 0.1, 0.1, 0.0, 0.2)^{T}
tr_{B}=(0.2, 0.0, 0.2, 0.0, 0.0, 0.0, 0.0, 0.0, 0.1, 0.3, 0.2)^{T}
tr_{C}=(0.0, 0.0, 0.0, 0.0, 0.0, 0.0, 0.0, 0.1, 0.1, 0.2, 0.0)^{T}
tr_{D}=(0.0, 0.0, 0.1, 0.0, 0.2, 0.1, 0.1, 0.2, 0.2, 0.0, 0.0)^{T}
tr_{E}=(0.0, 0.0, 0.2, 0.1, 0.2, 0.0, 0.0, 0.0, 0.0, 0.0, 0.0)^{T}
tr_{F}=(0.0, 0.0, 0.0, 0.0, 0.0, 0.1, 0.2, 0.0, 0.0, 0.0, 0.0)^{T}
tr_{G}=(0.0, 0.0, 0.1, 0.2, 0.2, 0.0, 0.0, 0.0, 0.0, 0.0, 0.0)^{T}

In this case, first elements, third elements, ninth elements and eleventh elements of the transition vector tr_{A} and the transition vector tr_{B} are co-occurring. Accordingly, the transition vector extraction unit 230 extracts a combination of the transition vector tr_{A} and the transition vector tr_{B} as the calculation target.

Moreover, only third elements of the transition vector tr_{A} and the transition vector E are co-occurring (there is a co-occurrence of one kind of element). Accordingly, the transition vector extraction unit 230 does not extract a combination of the transition vector tr_{A} and the transition vector tr_{E} as the calculation target.

FIG. 23 is a diagram showing an example of a combination of two transition vectors which the transition vector extraction unit 230 extracts. In FIG. 23, each transition vector is expressed as a node, and a combination of two transition vectors which are the calculation target is expressed by an edge.

As mentioned above, the transition vector extraction unit 230 generates, for example, the calculation target information which is shown in the following.
(tr_{A}-tr_{B}, tr_{A}-tr_{C}, tr_{A}-tr_{D}, tr_{B}-tr_{C}, tr_{B}-tr_{D}, tr_{C}-tr_{D}, tr_{D}-tr_{E}, tr_{D}-tr_{G}, tr_{D}-tr_{F}, tr_{E}-tr_{G})

<<<Second Extraction Handling>>>

In the case that, regarding a certain transition vector, there are (l−1) or more transition vectors (l of the first l-diversity) other than the certain transition vector each of which has non-′zero′ level of similarity to the certain transition vector, the transition vector extraction unit 230 extracts a combination of the certain transition vector and the other transition vector as the calculation target.

Here, in the case the scalar product between two transition vectors is applied as a level of similarity, the transition vector extraction unit 230 judges whether a level of similarity between the two transition vectors is ‘0’ or not by calculating the logical product between each element of one transition vector and each corresponding element of the other transition vector. That is, in the case that every logical product between the elements is ‘0’, the transition vector extraction unit 230 judges that the level of similarity between the two transition vectors is ‘0’. On the other hand, in the case that at least one of the logical products between the elements is not ‘0’, the transition vector extraction unit 230 judges that the level of similarity between the two transition vectors is not ‘0’.

For example, it is assumed that l of the first l-diversity is ‘3’. Moreover, a plurality of transition vectors which are process targets of the transition vector extraction unit 230 are defined as shown in the first extraction handling.

In this case, the other transition vectors each of which has non-′zero′ level of similarity to the transition vector tr_{A} are the transition vector tr_{B}, the transition vector tr_{C} and the transition vector tr_{D}. Accordingly, the transition vector extraction unit 230 extracts a set of the transition vector tr_{A} and the transition vector B and a combination of the transition vector tr_{A} and the transition vector C as the calculation target.

Moreover, a transition vector which is not the transition vector tr_{F} and which has non-′zero′ level of similarity to the transition vector tr_{F} is only the transition vector tr_{D}. Accordingly, the transition vector extraction unit 230 does not extract a combination of the transition vector tr_{F} and the other transition vector as the calculation target.

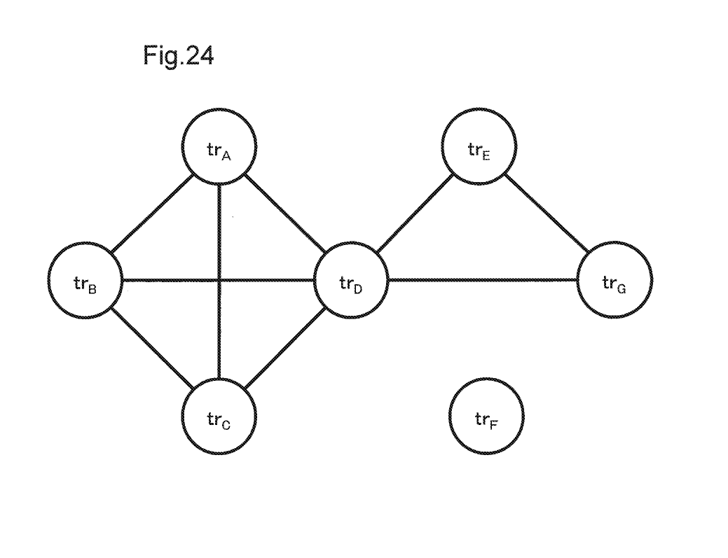

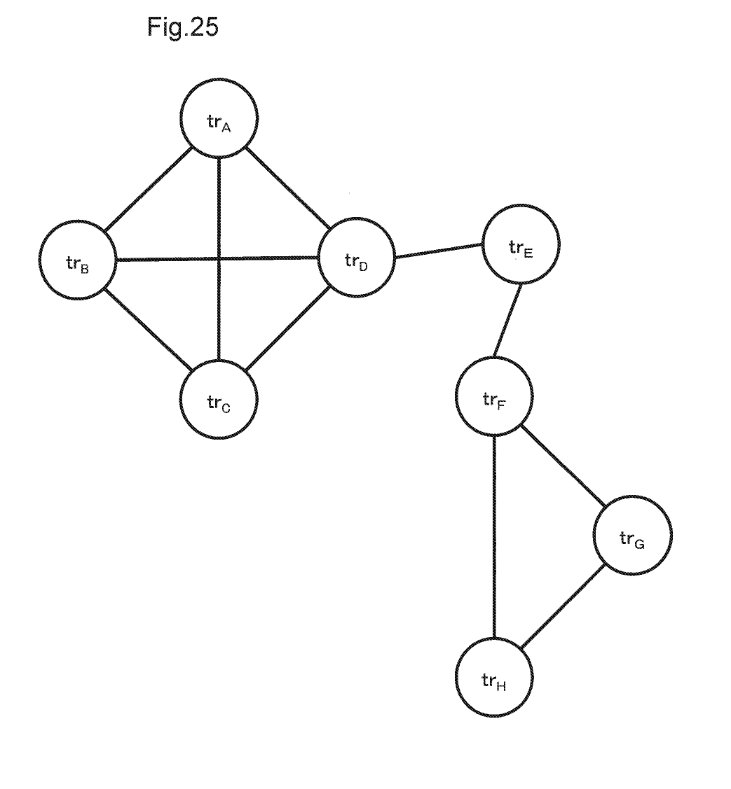

FIG. 24 is a diagram showing an example of a combination of two transition vectors which the transition vector extraction unit 230 extracts. In FIG. 24, each transition vector is expressed as a node, and a combination of two transition vectors which is the calculation target is expressed by an edge.

As mentioned above, the transition vector extraction unit 230 generates, for example, the calculation target information which is shown in the following.
(tr_{A}-tr_{B}, tr_{A}-tr_{C}, tr_{A}-tr_{D}, tr_{B}-tr_{C}, tr_{B}-tr_{D}, tr_{C}-tr_{D}, tr_{D}-tr_{E}, tr_{D}-tr_{G}, tr_{E}-tr_{G})

<<<Third Extraction Handling>>>

In the case that, with respect to transition vectors which include l kinds regarding the first l-diversity. any level of similarity between the transition vectors is not ‘0’, the transition vector extraction unit 230 extracts a combination of the transition vectors as the calculation target.

FIG. 25 is a schematic diagram showing whether a level of similarity between transition vectors, which are process target of the transition vector extraction unit 230, is ‘0’ or not. In FIG. 25, each transition vector is expressed as a node, and that a level of similarity between two transition vectors is ‘0’ is expressed by an edge.

For example, it is assumed that l of the first l-diversity is ‘3’. Since a level of similarity between any two transition vectors out of three transition vector tr_{A}, the transition vector tr_{B} and the transition vector tr_{C} is not ‘0’ (edge exists), the transition vector extraction unit 230 extracts a combination of the any two transition vectors as the calculation target. Moreover, since a level of similarity between the transition vector tr_{D} and the transition vector tr_{F} out of three transition vector tr_{D}, the transition vector tr_{E} and the transition vector tr_{F} is ‘0’, the transition vector extraction unit 230 does not extract a combination of the transition vector tr_{D}, the transition vector tr_{E} and the transition vector tr_{F} as the calculation target.

As mentioned above, the transition vector extraction unit 230 generates calculation target information, for example, which will be shown in the following.
(tr_{A}-tr_{B}, tr_{A}-tr_{C}, tr_{A}-tr_{D}, tr_{B}-tr_{C}, tr_{B}-tr_{D}, tr_{C}-tr_{D}, tr_{F}-tr_{G}, tr_{F}-tr_{H}, tr_{G}-tr_{H})

Similarly, in the case that l of the first l-diversity is ‘4’, the transition vector extraction unit 230 generates calculation target information which will be shown in the following.
(tr_{A}-tr_{B}, tr_{A}-tr_{C}, tr_{A}-tr_{D}, tr_{B}-tr_{C}, tr_{B}-tr_{D}, tr_{C}-tr_{D})

The above is explanation on handling of extracting the calculation target included in the calculation target information.

Here, the transition vector extraction unit 230 may carry out any one of the first, the second and the third extraction handlings or may carry out any combination among the first extraction handling, the second extraction handling and the third extraction handling.

===Record Extraction Unit 210===

The record extraction unit 210 outputs the generated transition vector to the transition vector extraction unit 230. Then, the record extraction unit 210 receives a result of extraction from the transition vector extraction unit 230.

For example, the record extraction unit 210 outputs the generated transition vector to the transition vector extraction unit 230 after Step S601 shown in FIG. 6. Then, when receiving the result of extraction from the transition vector extraction unit 230, the record extraction unit 210 carries out Step 602 and steps which follow Step S602.

Here, after Step S603 shown in FIG. 17, the record extraction unit 210 may output the transition vector except for the transition vector, which has been used, to the transition vector extraction unit 230. In this case, when receiving the result of extraction from the transition vector extraction unit 230, the record extraction unit 210 may carry out Step 602 and steps, which follow Step S602, again. Here, the transition vector which has been used is the transition vector corresponding to the assumption record which is extracted in Step S603.

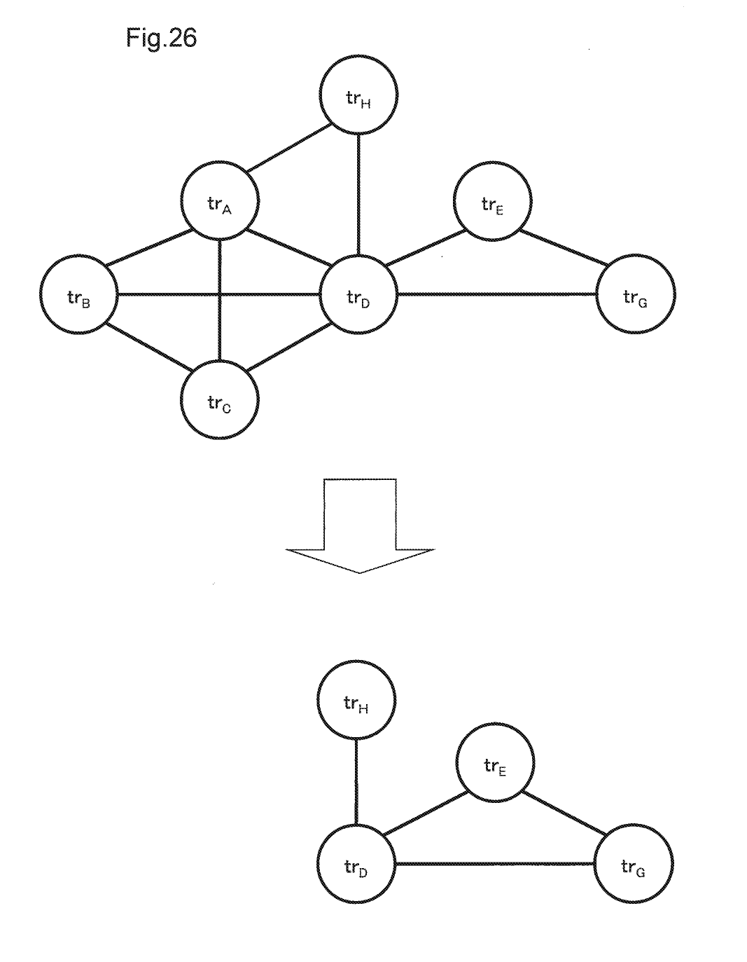

FIG. 26 is a diagram showing an example of the transition vector, which the record extraction unit 210 outputs, except for the transition vector which has been used. For example, it is assumed that the record extraction unit 210 uses the transition vector tr_{A}, the transition vector tr_{B} and the transition vector tr_{C} in Step S603 shown in FIG. 17. In this case, the record extraction unit 210 outputs the transition vector tr_{D}, the transition vector tr_{E}, the transition vector tr_{G} and the transition vector H except for the transition vector tr_{A}, the transition vector tr_{B} and the transition vector tr_{C} to the transition vector extraction unit 230.

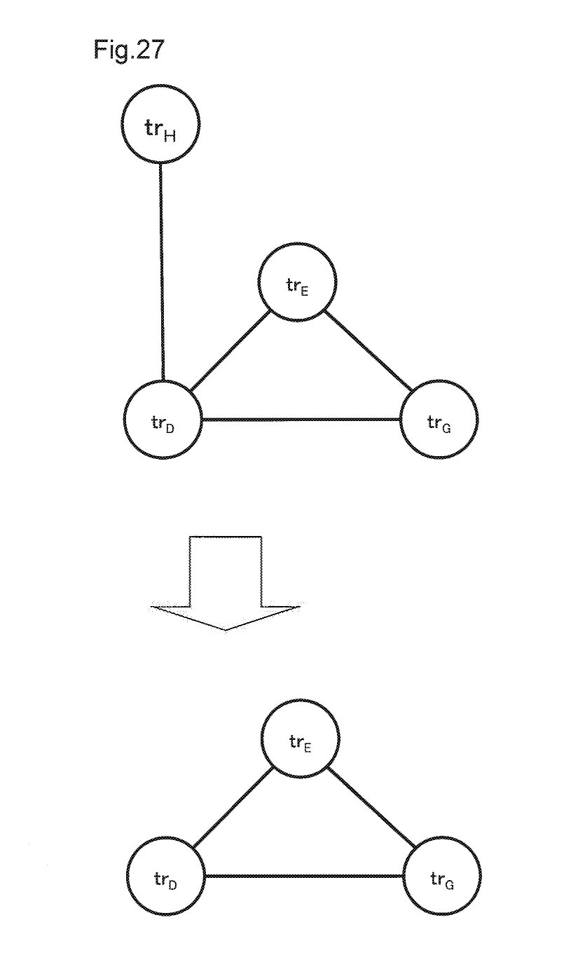

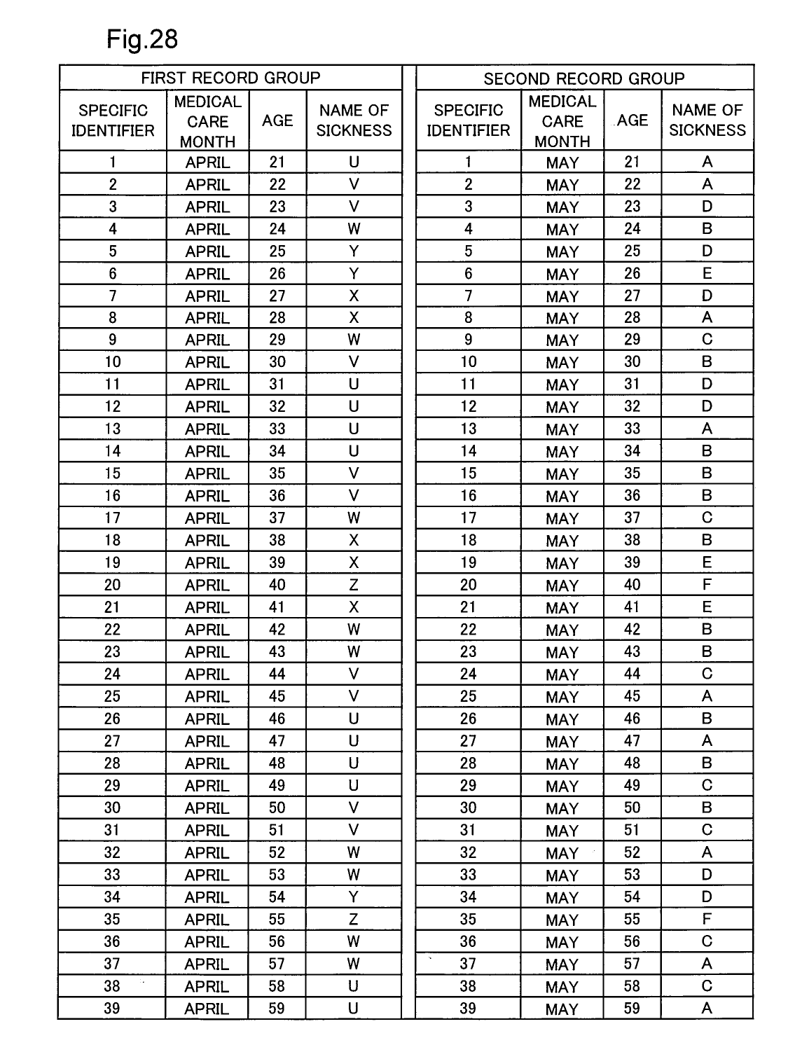

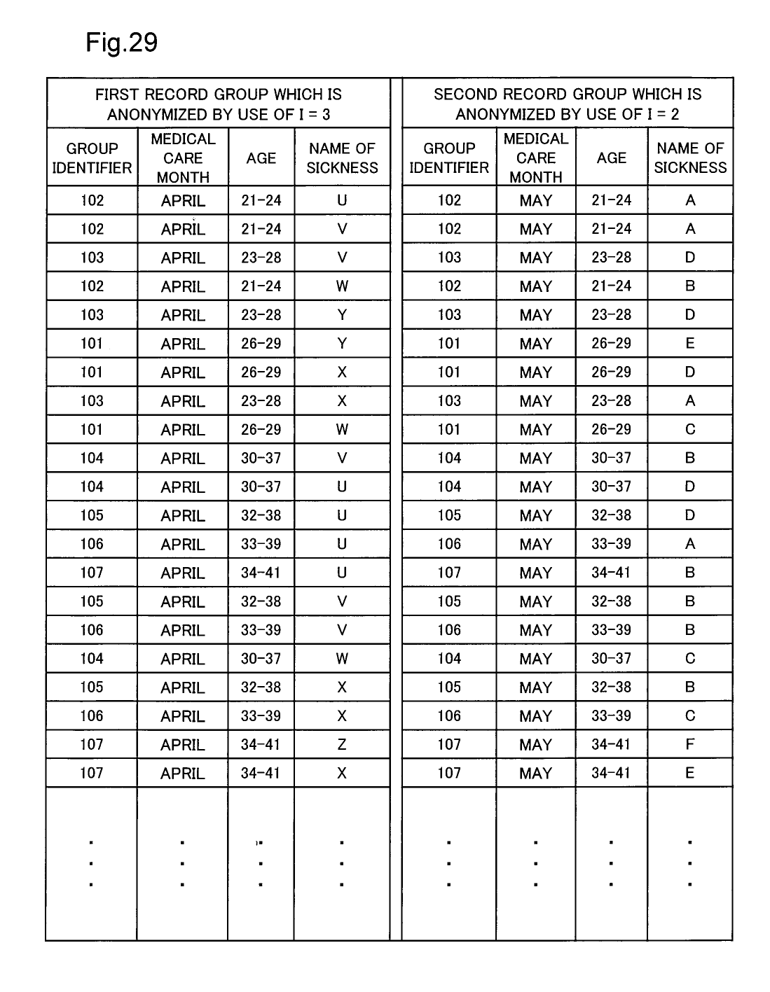

FIG. 27 is a diagram showing a combination of transition vectors, which are extracted as the calculation target, out of the transition vectors received from the record extraction unit 210 by the transition vector extraction unit 230. In this case, the transition vector extraction unit 230 generates calculation target information which will be shown in the following.
(tr_{D}-tr_{E}, tr_{D}-tr_{G}, tr_{E}-tr_{G})

In addition to the effect of the first exemplary embodiment, the second exemplary embodiment has a first effect in a point that it is possible to carry out efficient anonymization.

The reason is that the transition vector extraction unit 230 generates the calculation target information which indicates the target for calculating the level of similarity regarding the plural transition vectors, and the record extraction unit 210 calculates the level of similarity on the basis of the calculation target information. That is, the reason is that it is avoided to carry out a process of calculating an unnecessary level of similarity.

Moreover, since the record extraction unit 210 outputs the transition vector except for the transition vector, which has been used, to the transition vector extraction unit 230 and obtains the calculation target information, it is possible to make anonymization more efficient

It is not always necessary that the components, which have been explained in each exemplary embodiment, exist independently each other. For example, a plurality of the components may be realized by one module. Moreover, one component may be realized by a plurality of modules. Moreover, one component may have a configuration that the one component is a part of another component. Moreover, one component may have a configuration that a part of the one component overlaps with a part of another component.

Each component and a module which realizes each the component in the above-mentioned exemplary embodiment may be realized by hardware. Moreover, each component and a module which realizes each component may be realized by a computer and a program. Moreover, each component and a module which realizes each component may be realized by mixture of a hardware module with a computer and a program.

The program is recorded in a non-volatile computer readable recording medium such as a magnetic disk, a semi-conductor memory or the like and is provided by the non-volatile computer readable recording medium. Then, the program is read by a computer when activating the computer. By controlling an operation of CPU, the program makes CPU work as each the component which is described in each of the above-mentioned exemplary embodiments

Moreover, while a plurality of operations are described in turn in a form of the flowchart according to each of the exemplary embodiments mentioned above, the turn of the description does not limit a turn of carrying out a plurality of operations Therefore, it is possible to change the turn of the plural operation as far as the change does not cause a substantial trouble.

Furthermore, according to each of the exemplary embodiments mentioned above, a plurality of operations are not limited to being carried out at times different each other. For example, while one operation is being carried out, another operation may be activated, and an execution timing of one operation and an execution timing of another operation may overlap each other partially or entirely.

Furthermore, while it is described in each of the exemplary embodiments mentioned above that one operation activates another operation, the description does not limit each relationship between one operation and the other operation. Therefore, when carrying out each exemplary embodiment, each relationship between the operations can be changed as far as the change does not cause a substantial problem. The specific description on each operation of each component does not limit each operation of each component. Therefore, each specific operation of each component may be changed as far as the change does not cause a problem to characteristics of function, performance or the like

While the present invention has been described with reference to the exemplary embodiment, the present invention is not limited to the above-mentioned exemplary embodiment. Various changes, which a person skilled in the art can understand, can be added to the composition and the details of the invention of the present application in the scope of the invention of the present application.

This application claims priority based on the Japanese Patent Application No. 2012-212454 filed on Sep. 26, 2012 and the disclosure of which is hereby incorporated in its entirety.

### REFERENCE SIGNS LIST

100 anonymization device
101 anonymization system
110 record extraction unit
120 anonymous group generation unit
210 record extraction unit
230 transition vector extraction unit
500 history information storage unit
510 data set
521 assumption record portion
522 conclusion record portion
530 extracted record group
531 extracted assumption record group
532 extracted conclusion record group
540 common portion record group
541 common portion assumption record group
542 common portion conclusion record group
550 conclusion sort record group
551 conclusion sort assumption record group
552 conclusion sort conclusion record group
562 anonymous group conclusion record group
570 residual record
600 anonymization information storage unit
611 assumption anonymous group data set
612 conclusion anonymous group data set
700 computer
701 CPU
702 storage unit
703 storage device
704 input unit
705 output unit
706 communication unit
707 recording medium
5321 conclusion record

1. An information processing device, comprising:
a record extraction unit which extracts a plurality of second records from a data set, which includes plural sets of a first record including a specific identifier and at least one first attribute, and said second record including the same specific identifier as said specific identifier of said first record and at least one second attribute, on the basis that it is possible to satisfy a second l-diversity in a second record group including plural said second record, and it is possible to satisfy a first l-diversity in a first record group including said first record which makes the set with said second record included in said second group, and on the basis of a level of abstraction of a correspondence relationship existing between said first record and said second record; and
an anonymous group generation unit which generates an anonymous group data set including said second record, which is extracted by said record extraction unit, so as to satisfy said second l-diversity in said anonymous group data set and so as to satisfy said first l-diversity in said first record group including said first record which makes the set with said second record included in said anonymous group data set, and outputs said generated anonymous group data set.

2. The information processing device according to claim 1, characterized in that:
said anonymous group generation unit assigns said anonymous group data set and an assumption anonymous group data set, which is generated by anonymizing plural said first records each of which makes the set with said second record included in said anonymous group data set, information which indicates said correspondence relationship between said second record included in said anonymous group data set and said first record included in said anonymous group data set, and outputs said anonymous group data set and said assumption anonymous group data set which are assigned said information.

3. The information processing device according to claim 1, characterized in that:
said record extraction unit:
generates a transition vector whose element is appearance frequency per an attribute value of said first attribute included in said first record that each second attribute value of a second attribute included in said second record appears in said second record which makes said set with said first record;
calculates a level of similarity between said transition vectors by use of a definition that, in the case that number of said second attribute values of said second attribute, which are common between said second records corresponding two said transition vectors respectively, is smaller than number of kinds regarding said second l-diversity, a level of similarity between two said transition vectors is 0 which is the minimum value; and
extracts said second record making the set with said first record, which has said first attribute value and which is corresponding to each of said transition vectors which are listed in an order of relative largeness of said level of similarity and whose number is said number of kinds regarding said first l-diversity, as said second record which has relatively low level of abstraction.

4. The information processing device according to claim 3, characterized in that:
the information processing device includes furthermore a transition vector extraction unit which generates calculation target information indicating a target for calculating said level of similarity regarding plural said transition vectors, and outputting said calculation target information; and
said record extraction unit outputs said generated transition vector to said transition vector extraction unit, and obtains said calculation target information from said transition vector extraction unit.

5. The information processing device according to claim 4, characterized in that:
said record extraction unit outputs said generated transition vector, which does not include said transition vector corresponding to said extracted first record, to said transition vector extraction unit.

6. The information processing device according to claim 1, characterized in that:
said anonymous group generation unit generates said anonymous group data set so that number of kinds of said correspondence relationship between said attribute value of said second attribute of said second record included in said anonymous group data set, and anonymized said attribute value of said first attribute of said first record included in said first record group may not be increased.

7. The information processing device according to claim 6, characterized in that:
said anonymous group generation unit adds furthermore said second record, which can be added so that abstracting said correspondence relationship may not be caused said anonymous group data set and which is not included in said anonymous group data set, to said anonymous group data set.

8. The information processing device according to claim 6, characterized in that:
said anonymous group generation unit extracts furthermore a set of said second records, which can be anonymized by satisfying said second l-diversity and which enables said first l-diversity to be satisfied in a set of said first records each of which makes the set with said second record able to be anonymized by satisfying said second l-diversity, from said second records which are not included in said anonymous group data set, and adds said extracted set of second records to said anonymous group data set.

9. An anonymization method according to which a computer:
extracts a plurality of second records from a data set, which includes plural sets of a first record including a specific identifier and at least one first attribute, and said second record including the same specific identifier as said specific identifier of said first record and at least one second attribute, on the basis that it is possible to satisfy a second l-diversity in a second record group including said second record, and it is possible to satisfy a first l-diversity in a first record group including said first record which makes the set with said second record included in said second group, and on the basis of a level of abstraction of a correspondence relationship existing between said first record and said second record; and
generates an anonymous group data set including said extracted second record so as to satisfy said second l-diversity in said anonymous group data set and so as to satisfy said first l-diversity in said first record group including said first record which makes the set with said second record included in said anonymous group data set, and outputs said generated anonymous group data set.

10. The anonymization method according to claim 9, characterized in that: extraction of said second record, comprising:
generating a transition vector whose element is appearance frequency per an attribute value of said first attribute included in said first record that each second attribute value of a second attribute included in said second record appears in said second record which makes said set with said first record;
calculating a level of similarity between said transition vectors by use of a definition that, in the case that number of said second attribute values of said second attribute, which are common between said second records corresponding two said transition vectors respectively, is smaller than number of kinds regarding said second l-diversity, a level of similarity between two said transition vectors is 0 which is the minimum value; and
extracting said second record making the set with said first record, which has said first attribute value and which is corresponding to each of said transition vectors which are listed in an order of relative largeness of said level of similarity and whose number is said number of kinds regarding said first l-diversity, as said second record which has relatively low level of abstraction.

11. The anonymization method according to claim 10, characterized in that:
furthermore, said computer generates calculation target information indicating a target for calculating said level of similarity regarding plural said transition vectors, and outputs said calculation target information; and
in extraction of said second record, said computer calculates said level of similarity between said transition vectors on the basis of said calculation target information corresponding to said generated transition vector.

12. A computer-readable non-transitory recording medium which stores a program for making a computer execute:
a process to extract a plurality of second records from a data set, which includes plural sets of a first record including a specific identifier and at least one first attribute, and said second record including the same specific identifier as said specific identifier of said first record and at least one second attribute, on the basis that it is possible to satisfy a second l-diversity in a second record group including said second record, and it is possible to satisfy a first l-diversity in a first record group including said first record which makes the set with said second record included in said second group, and on the basis of a level of abstraction of a correspondence relationship existing between said first record and said second record; and
a process to generate an anonymous group data set including said extracted second record so as to satisfy said second l-diversity in said anonymous group data set and so as to satisfy said first l-diversity in said first record group including said first record which makes the set with said second record included in said anonymous group data set, and to output said generated anonymous group data set.

13. The computer-readable non-transitory recording medium according to claim 12 which stores said program for making said computer execute furthermore:
generating a transition vector whose element is appearance frequency per an attribute value of said first attribute included in said first record that each second attribute value of a second attribute included in said second record appears in said second record which makes said set with said first record;
calculating a level of similarity between said transition vectors by use of a definition that, in the case that number of said second attribute values of said second attribute, which are common between said second records corresponding two said transition vectors respectively, is smaller than number of kinds regarding said second l-diversity, a level of similarity between two said transition vectors is 0 which is the minimum value; and
extracting said second record making the set with said first record, which has said first attribute value and which is corresponding to each of said transition vectors which are listed in an order of relative largeness of said level of similarity and whose number is said number of kinds regarding said first l-diversity, as said second record which has relatively low level of abstraction,
in a process of extracting said second record.

14. The computer-readable non-transitory recording medium storing the program according to claim 13 which stores said program for making said computer execute furthermore:
a process of generating calculation target information which indicates a target for calculating said level of similarity regarding plural said transition vectors, and outputting said calculation target information; and
a process of calculating said level of similarity between said transition vectors in extraction of said second record on the basis of said calculation target information corresponding to said generated transition vector.
